(19) United States
(12) Patent Application Publication
(10) Pub. No.: US 2019/0102634 A1
(43) Pub. Date: Apr. 4, 2019

(54) PARKING POSITION DISPLAY PROCESSING APPARATUS, PARKING POSITION DISPLAY METHOD, AND PROGRAM

(71) Applicant: SHARP KABUSHIKI KAISHA, Osaka (JP)

(72) Inventors: NAOTO SAGAMI, Sakai City (JP); TOMOYA SHIMURA, Sakai City (JP)

(21) Appl. No.: 16/148,770

(22) Filed: Oct. 1, 2018

(30) Foreign Application Priority Data
Oct. 2, 2017 (JP) 2017-193099

(51) Int. Cl. G06K 9/00

(52) U.S. Cl. CPC G06K 9/00812; G06K 9/00838; G06K 9/00825

(57) ABSTRACT

A parking position display processing apparatus includes: an image capturing unit that captures an image of a surrounding of a vehicle and generates a captured image; a vehicle information acquisition unit that acquires vehicle information of the vehicle; a vehicle surrounding state recognition unit that generates vehicle surrounding information which indicates a state of a surrounding of the vehicle based on the captured image and the vehicle information; a parking position calculation unit that calculates a planned parking position of the vehicle based on the vehicle surrounding information and the vehicle information; a composite image generation unit that generates a composite image from an image which represents the planned parking position and an image which represents the state of the surrounding of the vehicle in the planned parking position based on the planned parking position and the vehicle surrounding information; and a display unit that displays the composite image.

### BACKGROUND

### 1. Field

The present disclosure relates to a parking position display processing apparatus, a parking position display method, and a program.

### 2. Description of the Related Art

There has been a technique which performs superimposition display of an image of a vehicle that is parked at a planned parking position on a surrounding environment image of the vehicle and is capable of checking a situation of the parked vehicle before parking is started (for example, see Japanese Unexamined Patent Application Publication No. 11-208420).

Further, there has been a technique which sets a target parking position and advises another riding member than a driver to get off a vehicle before parking at a target parking position in consideration of a space for door operation, which is secured on a lateral side of the vehicle which is parked at the target parking position, and an allowable angle in which the door operation is possible (for example, see Japanese Unexamined Patent Application Publication No. 2010-202071).

However, even if a case where the technique disclosed in Japanese Unexamined Patent Application Publication No. 11-208420 is used, in a case where a planned parking position is changed, it is requested to manually adjust the planned parking position after a vehicle is temporarily stopped or to move the vehicle until the planned parking position in a surrounding environment image of the vehicle becomes a desired position. Accordingly, there has been a problem in that trouble for a driver is large. Further, even if the technique disclosed in Japanese Unexamined Patent Application Publication No. 2010-202071 is used, it is requested to in advance set an allowable angle in which a door operation is possible. Another riding member than a driver has to in advance get off a vehicle depending on the setting of the allowable angle even in a case where a space for the door operation is secured. Accordingly, there has been a problem in that convenience is not sufficient.

As described above, there has been a problem in that convenience for riding members such as the driver and a passenger in a case where the vehicle is parked is not sufficient.

It is desirable to provide a parking position display processing apparatus, a parking position display method, and a program that may improve convenience for riding members in a case where a vehicle is parked.

### SUMMARY

According to a first aspect of the disclosure, there is provided a parking position display processing apparatus including: an image capturing unit that captures an image of a surrounding of a vehicle and generates a captured image; a vehicle information acquisition unit that acquires vehicle information of the vehicle; a vehicle surrounding state recognition unit that generates vehicle surrounding information which indicates a state of a surrounding of the vehicle based on the captured image and the vehicle information; a parking position calculation unit that calculates a planned parking position of the vehicle based on the vehicle surrounding information and the vehicle information; a composite image generation unit that generates a composite image from an image which represents the planned parking position and an image which represents the state of the surrounding of the vehicle in the planned parking position based on the planned parking position and the vehicle surrounding information; and a display unit that displays the composite image.

According to a second aspect of the disclosure, there is provided a parking position display method causing a computer of a parking position display processing apparatus that includes an image capturing unit which captures an image of a surrounding of a vehicle and generates a captured image and a display unit to execute a process including: acquiring vehicle information of the vehicle; generating vehicle surrounding information that indicates a state of a surrounding of the vehicle based on the captured image and the vehicle information; calculating a planned parking position of the vehicle based on the vehicle surrounding information and the vehicle information; generating a composite image from an image which represents the planned parking position and an image which represents the state of the surrounding of the vehicle in the planned parking position based on the planned parking position and the vehicle surrounding information; and displaying the composite image by the display unit.

According to a third aspect of the disclosure, there is provided a program causing a computer of a parking position display processing apparatus that includes an image capturing unit which captures an image of a surrounding of a vehicle and generates a captured image and a display unit to execute a process including: acquiring vehicle information of the vehicle; generating vehicle surrounding information that indicates a state of a surrounding of the vehicle based on the captured image and the vehicle information; calculating a planned parking position of the vehicle based on the vehicle surrounding information and the vehicle information; generating a composite image from an image which represents the planned parking position and an image which represents the state of the surrounding of the vehicle in the planned parking position based on the planned parking position and the vehicle surrounding information; and displaying the composite image by the display unit.

### BRIEF DESCRIPTION OF THE DRAWINGS

FIG. 1 is a schematic diagram that illustrates one example of a configuration of a parking position display system according to a first embodiment of the present disclosure;

FIG. 2 is a bird's-eye diagram that illustrates one example of an assumed environment according to the first embodiment of the present disclosure;

FIG. 3 is a display example that illustrates one example in which a photographed image by a rear camera is displayed by a display, according to the first embodiment;

FIG. 4 is a schematic block diagram that illustrates one example of a function configuration of a parking position display processing apparatus according to the first embodiment of the present disclosure;

FIG. 5 is a flowchart that illustrates one example of a parking position display process according to the first embodiment of the present disclosure;

FIG. 6 is a bird's-eye diagram of the vehicle according to a second embodiment of the present disclosure;

FIG. 7 is a schematic block diagram that illustrates one example of a function configuration of the parking position display processing apparatus according to the second embodiment of the present disclosure;

FIGS. 8A to 8D are explanatory diagrams that illustrate examples of vehicle images according to the second embodiment of the present disclosure;

FIG. 9 is a flowchart that illustrates one example of a parking position display process according to the second embodiment of the present disclosure;

FIG. 10 is a flowchart that illustrates one example of the parking position display process according to the second embodiment of the present disclosure;

FIG. 11 is a flowchart that illustrates one example of the parking position display process according to the second embodiment of the present disclosure;

FIG. 12 is an explanatory diagram that illustrates one example of a display image according to a third embodiment of the present disclosure;

FIG. 13 is an explanatory diagram that illustrates one example of an image which represents an opening amount of a door of the vehicle according to the third embodiment of the present disclosure;

FIGS. 14A and 14B are explanatory diagrams that illustrate examples of display images according to a fourth embodiment of the present disclosure;

FIGS. 15A to 15C are explanatory diagrams that illustrate examples of the display images according to the fourth embodiment of the present disclosure;

FIG. 16 is a schematic block diagram that illustrates one example of a function configuration of the parking position display processing apparatus according to a fifth embodiment of the present disclosure;

FIG. 17 is a flowchart that illustrates one example of a parking position display process according to the fifth embodiment of the present disclosure;

FIG. 18 is a flowchart that illustrates one example of a parking position display process according to a modification example of the fifth embodiment of the present disclosure;

FIG. 19 is a schematic block diagram that illustrates one example of a function configuration of the parking position display processing apparatus according to a sixth embodiment of the present disclosure;

FIGS. 20A and 20B are explanatory diagrams that illustrate examples of feedback force control according to the sixth embodiment of the present disclosure;

FIGS. 21A and 21B are explanatory diagrams that illustrate examples of the feedback force control according to the sixth embodiment of the present disclosure;

FIGS. 22A and 22B are explanatory diagrams that illustrate examples of the feedback force control according to the sixth embodiment of the present disclosure; and

FIG. 23 is a flowchart that illustrates one example of a parking position display process according to the sixth embodiment of the present disclosure.

### DESCRIPTION OF THE EMBODIMENTS

Embodiments of the present disclosure will hereinafter be described in detail with reference to drawings.

### First Embodiment

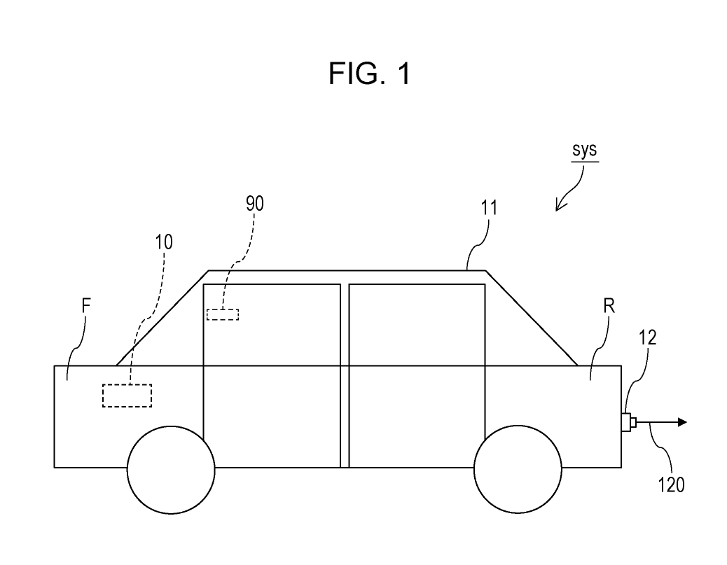

FIG. 1 is a schematic diagram that illustrates one example of a configuration of a parking position display system sys according to a first embodiment of the present disclosure.

The example illustrated in FIG. 1 is one example of a side diagram of a vehicle 11. The parking position display system sys is configured to include a parking position display processing apparatus 10, the vehicle 11, a rear camera 12, and a display 90. The parking position display processing apparatus 10 is arranged in an internal portion of a vehicle body of a front portion F of the vehicle 11, for example, and performs various image processes for a photographed image.

The rear camera 12 is arranged in a rear portion R of the vehicle 11 and photographs a surrounding environment on the outside of the vehicle 11. The rear camera 12 includes an image capturing element (not illustrated) such as a charge coupled device (CCD) sensor or a complementary metal oxide semiconductor (CMOS) sensor, an image capturing lens (which is not illustrated), and a signal processing unit, for example, forms an image on the image capturing element via the image capturing lens, and thereby photographs (generates) an image. In the example illustrated in FIG. 1, an optical axis of the image capturing lens is denoted as optical axis 120. The rear camera 12 is a wide-angle camera whose horizontal angle of view is 60 degrees or more and is arranged in the rear of the vehicle 11 such that the direction of the optical axis 120 is rearward in the vehicle 11, for example. Here, it is desirable that a horizontal (or vertical) angle of view, in which photographing in the legal viewing field range is possible, of the rear camera 12 is a wide angle. However, rear cameras are not limited to this, but two or more cameras whose horizontal (or vertical) angles of view are not wide angles may be used in the rear portion R of the vehicle 11, for example. In this case, a process for camera calibration may be conducted. In the following description, an image that is generated by the rear camera 12 will also be referred to as generated image.

The display 90 is a display apparatus such as a liquid crystal display or an organic EL display, for example, and displays an image for which image processing is conducted by the parking position display processing apparatus 10.

Note that the parking position display processing apparatus 10, the rear camera 12, and the display 90 may each be provided as dedicated devices or processing units, share a portion of various control apparatuses of illumination equipment, air conditioner, and so forth in the vehicle, or be incorporated in a portion of the various control apparatuses. Further, the rear camera 12 and the parking position display processing apparatus 10 may integrally be configured or arranged.

In the following, a description will be made about one example of an assumed environment in a case where the vehicle 11 in which the parking position display system is installed moves backward and parking position display that is displayed on the display 90.

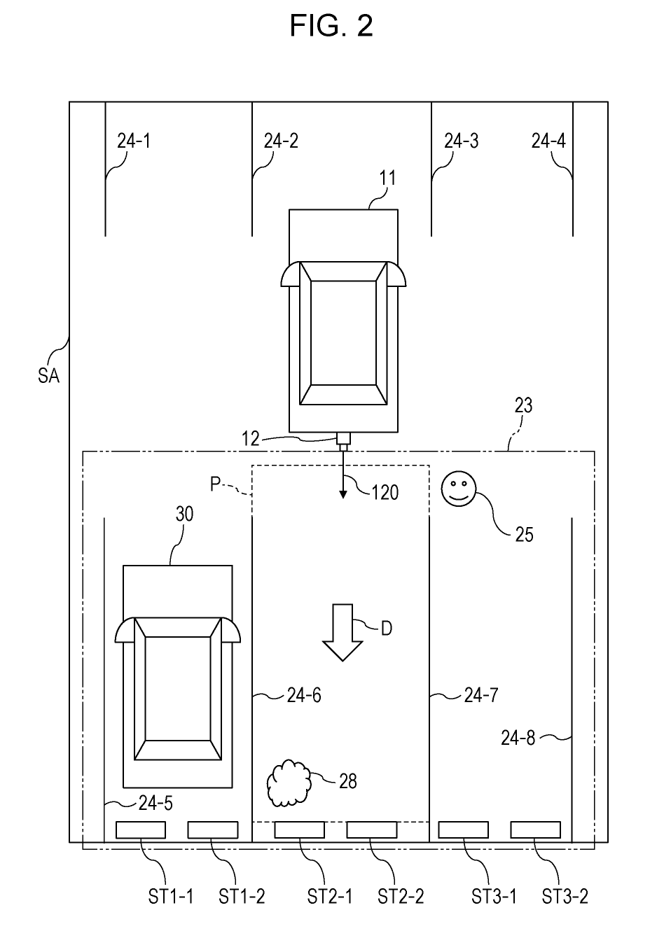

FIG. 2 is a bird's-eye diagram that illustrates one example of the assumed environment according to the first embodiment of the present disclosure.

The assumed environment is a parking lot, for example, and the example illustrated in FIG. 2 is one example of a bird's-eye diagram of a region SA of a portion of the parking lot.

In the region SA, zone lines 24-1, 24-2, 24-3, 24-4, 24-5, 24-6, 24-7, and 24-8, which indicate parking zones of vehicles, are arranged, and stop blocks ST1-1, ST1-2, ST2-1, ST2-2, ST3-1, and ST3-2 are each arranged for the parking zones. Here, in a case where the zone lines 24-1, 24-2, 24-3, 24-4, 24-5, 24-6, 24-7, and 24-8 are not distinguished or any of the zone lines are indicated, those will be referred to as zone line 24. Further, in a case where the stop blocks ST1-1, ST1-2, ST2-1, ST2-2, ST3-1, and ST3-2 are not distinguished or any of the stop blocks are indicated, those will be referred to as stop block ST.

Here, a description will be made about one example in which the vehicle 11 is parked at a parking zone P. The parking zone P is the zone that is interposed between the zone lines 24-6 and 24-7, for example.

In the region SA, the vehicle 11 attempts to park at the parking zone P by traveling (traveling backward) toward the rear of the vehicle 11 in which the rear camera 12 is arranged, that is, in the direction of the optical axis 120 of the rear camera 12, in a traveling direction D. Here, the vehicle 11 photographs the direction of the optical axis 120, that is, the rear of the vehicle 11 by the rear camera 12 placed in a rear portion of the vehicle 11. The rear camera 12 is capable of photographing in a range of a parking position display region 23, for example.

In the example illustrated in FIG. 2, a water puddle 28 is present in the parking zone P. In a case where the vehicle 11 parks at the parking zone P, the water puddle 28 becomes a caution spot, to which attention has to be paid and which is an unsuitable road in a case where a riding member gets off the vehicle after the vehicle 11 is parked, depending on the parking position of the vehicle 11 in the parking zone P. Further, in the example illustrated in FIG. 2, a neighboring vehicle 30 is parked at the parking zone on the left side of the parking zone P (the zone interposed between the zone lines 24-5 and 24-6). Further, in the example illustrated in FIG. 2, a pedestrian 25 is walking in the parking zone on the right side of the parking zone P (the zone interposed between the zone lines 24-7 and 24-8).

In a case where the vehicle 11 is parked at the parking zone P, the neighboring vehicle 30 and the pedestrian 25 become obstacles with which the vehicle 11 possibly contacts in a case of parking.

Next, a description will be made about one example in which an image that is photographed by the rear camera 12 of the vehicle 11 in the assumed environment is displayed by the display 90.

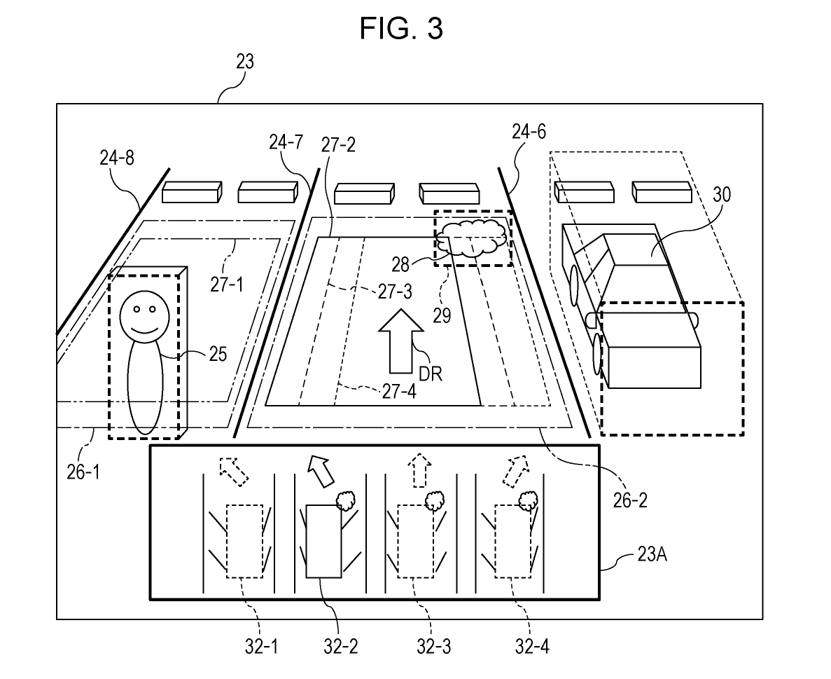

FIG. 3 is a display example that illustrates one example in which a photographed image by the rear camera 12 is displayed by the display 90, according to the first embodiment.

Here, it is assumed that the parking position display region 23 in FIG. 2 corresponds to the parking position display region 23 in FIG. 3.

The example illustrated in FIG. 3 is an image of the parking position display region 23 that is photographed by the rear camera 12 of the vehicle 11 in a case where the vehicle 11 moves backward and performs a parking action. The image of the parking position display region 23 is an image (video) that is obtained by performing various kinds of image processing for a portion or a whole image (video) which is photographed by the rear camera 12. The image of the parking position display region 23 is displayed on the display 90 included in the vehicle 11.

In the example illustrated in FIG. 3, the parking zones at which the vehicle 11 is capable of being parked are available parking ranges 26-1 and 26-2. In a case where the available parking ranges are not distinguished, the available parking range will be referred to as available parking range 26. The available parking ranges 26 are displayed in the parking position display region 23 in a case where the vehicle 11 is capable of being parked at the parking zones that are surrounded by zone lines 24. In a case where the available parking ranges 26 are displayed, parking positions 27-1, 27-2, 27-3, and 27-4 are displayed in the parking position display region 23, and vehicle images 32-1, 32-2, 32-3, and 32-4 are displayed in a safety information display region 23A. In a case where the parking positions 27-1, 27-2, 27-3, and 27-4 are not distinguished, the parking position will be referred to as parking position 27. Further, in a case where the vehicle images 32-1, 32-2, 32-3, and 32-4 are not distinguished, the vehicle image will be referred to as vehicle image 32.

The parking positions 27 indicate the position (planned parking position) in a case where the vehicle 11 is parked at the available parking range 26 and the requested area for parking of the vehicle 11. Further, the vehicle image 32 indicates the image that represents the position of the vehicle 11 in a case where the vehicle 11 is parked at the parking position 27 and the opening amounts of doors of the vehicle 11.

As described above, the parking positions 27 and the vehicle images 32 in a case where the vehicle 11 is parked at the parking positions 27 are displayed, and then a driver may select an arbitrary position from the vehicle images 32 and perform parking. Further, because the driver does not have to perform settings of various parameters about the rear camera 12 and parking assistances, convenience for a user may be improved. Further, the driver or a getting-off person may check the parking position (including peripheral obstacles) of the vehicle 11 that is parked and the opening amounts of the doors of the parked vehicle 11 before parking.

Here, in the example illustrated in FIG. 3, the pedestrian 25 and the neighboring vehicle 30 are objects (obstacles) that possibly contact with the vehicle 11 in a case where the vehicle 11 is parked as described above. Because presence of the obstacle has to be informed to the driver, the obstacle is emphatically displayed as illustrated in FIG. 3.

Further, the water puddle 28 is a caution spot 29 to which attention has to be paid in a case where the riding member gets off the vehicle 11 and because presence of the caution spot has to be informed to the driver or the getting-off person, the caution spot 29 is emphatically displayed as illustrated in FIG. 3.

As described above, the image processing is conducted for an image photographed by the rear camera 12, the obstacle or the caution spot in the image is detected and emphatically displayed, and thereby the situation around the vehicle 11 such as presence of an object in the rear of the vehicle 11 may be notified (reported) to the driver and the getting-off person of the vehicle 11.

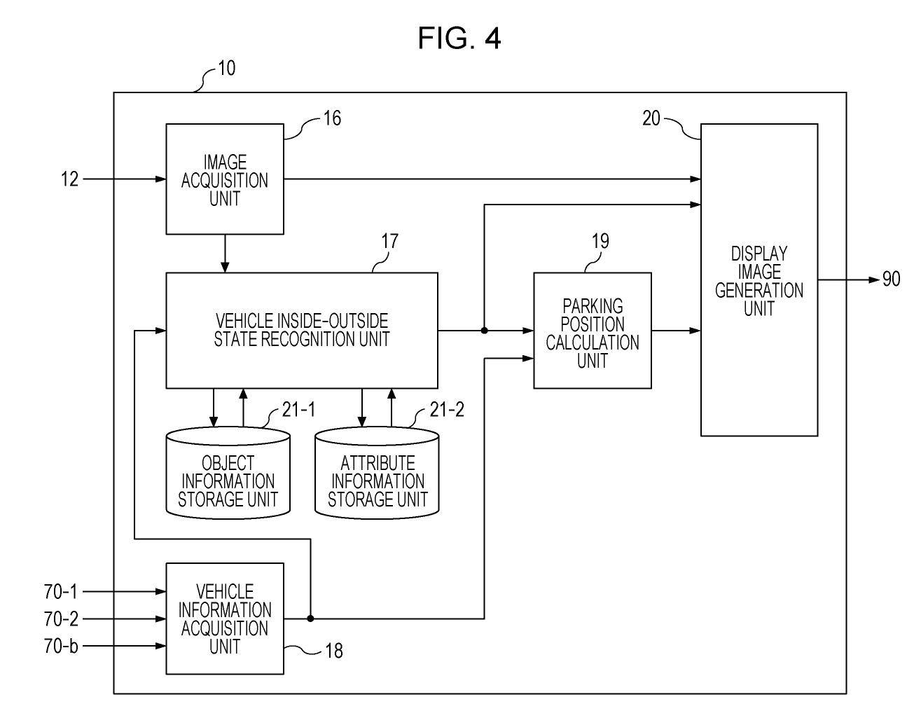

FIG. 4 is a schematic block diagram that illustrates one example of a function configuration of the parking position display processing apparatus 10 according to the first embodiment of the present disclosure.

The parking position display processing apparatus 10 is configured to include an image acquisition unit 16, a vehicle inside-outside state recognition unit 17, a vehicle information acquisition unit 18, a parking position calculation unit 19, a display image generation unit 20, an object information storage unit 21-1, and an attribute information storage unit 21-2.

The image acquisition unit 16 acquires an image signal that represents a generated image which is input by the rear camera 12. The image acquisition unit 16 outputs the acquired image signal to the vehicle inside-outside state recognition unit 17 and the display image generation unit 20.

Note that the image acquisition unit 16 may acquire the image signal from the rear camera 12 via a wired communication cable, may wirelessly acquire the image signal from the rear camera 12, may acquire the image signal of the rear camera 12 via another apparatus, a network, or the like, or may acquire the image signal of the rear camera 12 by another method.

Further, the image acquisition unit 16 may convert the image signal that is input from the rear camera 12 into an image signal that is suitable for image processing (signal processing) in the vehicle inside-outside state recognition unit 17, the display image generation unit 20, and so forth. In such a manner, regardless of the model of the rear camera 12 or the kind of the image signal output by the rear camera 12, the parking position display processing apparatus 10 may acquire the image signal.

In a case where the image signal is input from the image acquisition unit 16, the vehicle inside-outside state recognition unit 17 detects the objects in the image represented by the image signal and the coordinates of the objects. The vehicle inside-outside state recognition unit 17 causes the object information storage unit 21-1 to store the coordinate information of the detected objects. Further, the vehicle inside-outside state recognition unit 17 discriminates the kinds of the detected objects. The vehicle inside-outside state recognition unit 17 causes the attribute information storage unit 21-2 to store the discrimination results of the objects. The vehicle inside-outside state recognition unit 17 outputs detection information that includes the coordinate information of the detected objects and the discrimination results of the objects to the parking position calculation unit 19 and the display image generation unit 20.

As described above, the vehicle inside-outside state recognition unit 17 stores the coordinates of the object and the discrimination result of the object at the same address but separately in the object information storage unit 21-1 and the attribute information storage unit 21-2 and may thereby associate pieces of information when those are read out.

Note that the vehicle inside-outside state recognition unit 17 calculates a feature (for example, a histogram of oriented gradient feature) in the image based on the input image signal, performs a predetermined process (for example, an AdaBoost algorithm, a support vector machine algorithm, or the like), and may thereby detect an object. Further, a method by which the vehicle inside-outside state recognition unit 17 detects objects is not limited to the above, but any method of detecting an object from an input image signal may be used.

Note that the vehicle inside-outside state recognition unit 17 calculates the feature in the image based on the input image signal, categorizes the calculated feature by learning data that are in advance calculated by machine learning or the like, and may thereby discriminate the object. Further, a method by which the vehicle inside-outside state recognition unit 17 discriminates an object is not limited to the above, but any method that is capable of discrimination of an object may be used.

The vehicle information acquisition unit 18 acquires pieces of vehicle information 1-1, 1-2, and 1-b (b is a predetermined integer that is equal to or more than one) that are acquired by sensors 70-1, 70-2, and 70-b (b is a predetermined integer that is equal to or more than one). The vehicle information is information that is acquired by each of the sensors 70-b placed in the vehicle 11 and includes information such as the vehicle width of the vehicle 11, the full length (vehicle length) of a vehicle body of the vehicle 11, the traveling direction of the vehicle 11, and the open-close state of the door of the vehicle 11. The information of the open-close state of the door of the vehicle 11 includes angle information in a case where the door is open, in addition to opening and closing of the door of the vehicle 11.

The vehicle information acquisition unit 18 outputs the acquired vehicle information 1-b to the parking position calculation unit 19.

Note that an acquisition method of the vehicle information acquired by each of the sensors 70-b is not limited to the above, but the vehicle information may be acquired via the wired cable, may be acquired wirelessly, or may be acquired by any method. Further, the vehicle information may include a vehicle signal (for example, vehicle position information or the like) that is obtained from a sensor placed in the vehicle 11. Further, as for the vehicle information, new information may be generated by combining plural vehicle signals. For example, the vehicle information that indicates the traveling direction of the vehicle may be generated from the vehicle signal that represents a steering wheel angle and the vehicle signal of a vehicle speed.

Note that the vehicle information acquisition unit 18 may output the acquired vehicle information 1-b to the vehicle inside-outside state recognition unit 17 and the parking position calculation unit 19. In this case, the vehicle inside-outside state recognition unit 17 may recognize the vehicle inside-outside state based on either one or both of the image signal output by the image acquisition unit 16 and the vehicle information output by the vehicle information acquisition unit 18. In a case where the vehicle inside-outside state is recognized by using only the vehicle information, image processing performed for the image signal is not requested. Thus, the calculation amount in the vehicle inside-outside state recognition unit 17 may be reduced. Next, in a case where the vehicle inside-outside state is recognized by using only the image signal, an algorithm for processing the image signal is changed to a face detection algorithm or an object detection algorithm, and plural pieces of information (the position of a person, the position of an obstacle, and so forth) may be acquired from the image signal. Further, in a case where the vehicle inside-outside state is recognized by using both of the vehicle information and the image signal, an output result of an image processing algorithm and detection information of the sensor may be combined. For example, in a case where the sensor for detecting an object that is present in the rear of the vehicle is placed on the outside of the vehicle, a detection result of the sensor and a result of performance of object detection from the image signal of the rear camera are combined, and an object is detected by both of the sensor and the image signal of the rear camera, an object is assessed as detected, and the reliability of a vehicle inside-outside state detection result may thereby be improved.

The parking position calculation unit 19 acquires position information (coordinate information) of the zone lines 24 in the detection information input from the vehicle inside-outside state recognition unit 17. The parking position calculation unit 19 calculates the distance between the zone lines 24 (such as between the zone lines 24-6 and 24-7, for example) in an image based on the position information of the zone lines 24. Further, the parking position calculation unit 19 acquires the information that indicates the vehicle width of the vehicle 11 as the vehicle information from the vehicle information acquisition unit 18 and performs comparative calculation between the distance between the zone lines 24 and the vehicle width.

Specifically, in a case where the vehicle width is shorter (less) than the calculated distance between the zone lines 24, that is, a case where there is a space at which the vehicle 11 may be parked between the zone lines 24, the parking position calculation unit 19 assesses the region interposed between the zone lines 24 as the available parking range and outputs information that indicates the available parking range as the assessment result to the display image generation unit 20. Further, in a case where the available parking range is present in the image, the parking position calculation unit 19 further acquires the full length (vehicle length) of the vehicle 11 as the vehicle information from the vehicle information acquisition unit 18, multiplies the vehicle width by the vehicle length, and thereby calculates the region that the vehicle 11 requests for parking. Further, the parking position calculation unit 19 arranges plural regions that the vehicle 11 requests for parking in the available parking ranges and outputs the coordinate information of the region that the vehicle 11 requests for parking as the parking position information to the display image generation unit 20. Here, the parking position calculation unit 19 assesses the place, in which the available parking range does not match the region which the vehicle 11 requests for parking, as an unavailable parking region (which is already the parking position of another vehicle) and outputs the coordinate information of the unavailable parking region as the parking position information to the display image generation unit 20.

The display image generation unit 20 performs superimposition display of the detection information input from the vehicle inside-outside state recognition unit 17 and the parking position information input from the parking position calculation unit 19 on the image signal input from the image acquisition unit 16 and thereby generates an image (superimposition image) of the parking position display region 23. The display image generation unit 20 causes the display 90 to display the generated superimposition image.

Further, in a case where the image signal is input from the image acquisition unit 16, the display image generation unit 20 extracts position information of an object and height information of the object from the detection information input from the vehicle inside-outside state recognition unit 17. The display image generation unit 20 generates a frame that indicates the object from the position information of the object and the height information of the object, which are extracted, superimposes the frame on the image signal, and thereby generates a frame superimposition image. Note that the display image generation unit 20 may emphasize the frame that indicates the object. In this case, the shape of the frame, the color of the frame, the line type of the frame, or the like may be changed, or the frame may be emphasized by any method as long as the riding member of the vehicle 11 who watches the image on the display 90 may distinguish the object from other objects (a background and so forth) in the image by the rear camera 12.

Further, the display image generation unit 20 generates a parking position image from the available parking range acquired as the parking position information from the parking position calculation unit 19, the unavailable parking region, and the detection information input from the vehicle inside-outside state recognition unit 17 and superimposes the parking position image on the image signal. The parking position image includes an image of an arrow that indicates the traveling direction of the vehicle 11 to the parking position (for example, the traveling direction D in FIG. 2), an image that represents the vehicle 11 in a case where the doors are opened after parking (for example, the vehicle image 32 in FIG. 3), and an image of an object in the available parking range detected by the vehicle inside-outside state recognition unit 17 (for example, the caution spot 29 in FIG. 3). The display image generation unit 20 arranges the image of the arrow that indicates the traveling direction of the vehicle 11 to the parking position in the parking position image such that the start point of the arrow is directed in the direction to the image center in the image by the rear camera 12 and the end point of the arrow is directed in the direction to the coordinates of the parking position in a camera image.

Next, the display image generation unit 20 calculates the respective door positions of the vehicle 11 in the planned parking positions in the available parking ranges and the respective opening amounts of the doors of the vehicle 11 in the planned parking positions based on the detection information. The display image generation unit 20 generates an image that represents a state where the doors are inclined (opened) in accordance with the respective calculated opening amounts of the doors (for example, the vehicle image 32 in FIG. 3). Further, the display image generation unit 20 generates the parking position image in which the vehicle 11 is imitated based on the vehicle width of the vehicle 11 and the full length of the vehicle 11 (for example, the image of the parking position 27 in FIG. 3), superimposes the parking position image on an image that represents the inside of the available parking range (for example, the image of the available parking range 26 in FIG. 3), and further superimposes the image that represents the state where the doors are inclined (opened) on the vehicle image. Here, the area represented by the vehicle image is a substantially equivalent area to the area indicated by the available parking range. In such a manner, the display image generation unit 20 generates, in the parking position image, an image of the vehicle 11 whose doors are opened.

Further, in a case where the display image generation unit 20 extracts the position information of an object from the detection information input from the vehicle inside-outside state recognition unit 17 and the position coordinates of the extracted object are in the available parking range, the display image generation unit 20 generates an object superimposition image in which the image which represents the detected object is superimposed on the parking position image.

As described above, the display image generation unit 20 generates the object superimposition image, and the driver of the vehicle 11 may thereby select an arbitrary parking position from the available parking ranges that are displayed on the display 90 and perform parking. Thus, convenience may be improved. Further, trouble with settings of various parameters about parking that are in advance performed by the driver may be lessened. In addition, because the getting-off person from the vehicle 11 may check the parking position of the vehicle 11 in the parking position selected by the driver and the space for opening the door, which is requested for getting off the vehicle, before the vehicle 11 is actually parked at the parking position, convenience may be improved.

The object information storage unit 21-1 stores object information. Further, the attribute information storage unit 21-2 stores a discrimination result of an object.

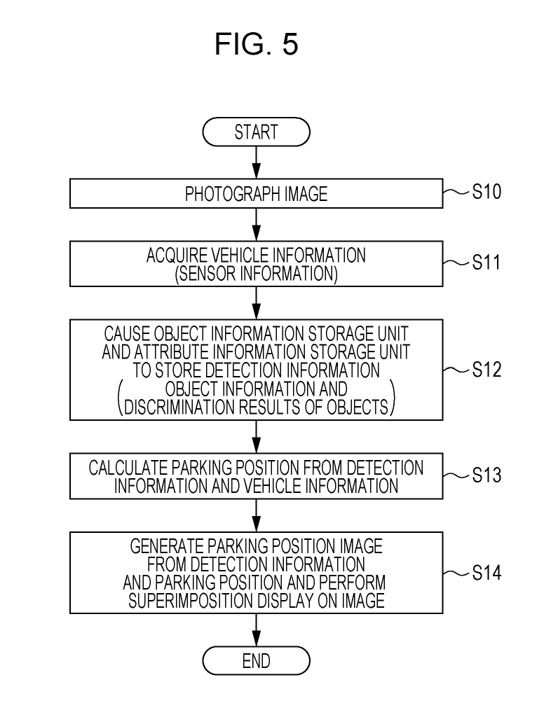

FIG. 5 is a flowchart that illustrates one example of a parking position display process according to the first embodiment of the present disclosure.

In step S10, the rear camera 12 is started when the vehicle 11 performs a backward movement action and starts photographing an image. The image acquisition unit 16 of the parking position display processing apparatus 10 acquires the image signal that represents an image that is photographed by the rear camera 12. Note that in a case where the format of the image signal is different from an image signal format that is identifiable (processable) for the parking position display processing apparatus 10, the image acquisition unit 16 may convert the image signal format or may cause another apparatus to perform format conversion and acquire the image signal in the converted format.

The parking position display processing apparatus 10 executes a process of step S11 after a process of step S10.

In step S11, the vehicle information acquisition unit 18 acquires the vehicle information 1-b (b is a predetermined integer that is equal to or more than one) (sensor information) of the vehicle 11 from the sensor 70-b and outputs the acquired vehicle information 1-b to the parking position calculation unit 19. The parking position display processing apparatus 10 executes a process of step S12 after the process of step S10.

In step S12, in a case where the image signal is input from the image acquisition unit 16, the vehicle inside-outside state recognition unit 17 detects objects in the image represented by the image signal and causes the object information storage unit 21-1 to store the coordinate information (object information) of the detected objects. Further, the vehicle inside-outside state recognition unit 17 performs discrimination about what the detected objects are (discrimination among the objects) and causes the attribute information storage unit 21-2 to store the discrimination results of the objects (attribute information). The vehicle inside-outside state recognition unit 17 outputs the object information (the coordinate information of the objects) and the discrimination results of the objects as the detection information (which will also be referred to as vehicle inside-outside state information) to the parking position calculation unit 19 and the display image generation unit 20.

Note that in step S12, the vehicle inside-outside state recognition unit 17 may detect the objects in the image represented by the image signal based on the image signal from the image acquisition unit 16 and the vehicle signal from the vehicle information acquisition unit 18 and may cause the object information storage unit 21-1 to store the coordinate information (object information) of the detected objects. Further, the vehicle inside-outside state recognition unit 17 may perform discrimination about what the detected objects are (discrimination among the objects) and cause the attribute information storage unit 21-2 to store the discrimination results of the objects (attribute information). In this case, the vehicle inside-outside state recognition unit 17 may output the object information (the coordinate information of the objects) and the discrimination results of the objects as the detection information (which will also be referred to as vehicle inside-outside state information) to the parking position calculation unit 19 and the display image generation unit 20.

In step S13, in a case where the detection information is input from the vehicle inside-outside state recognition unit 17, the parking position calculation unit 19 extracts the zone lines 24 from the attribute information and extracts and acquires the position information of the zone lines 24 that corresponds to the zone lines 24 from the coordinate information. Further, the parking position calculation unit 19 calculates the distance between the zone lines 24 in the image. Further, the parking position calculation unit 19 acquires the vehicle width of the vehicle 11 as the vehicle information. Then, the parking position calculation unit 19 calculates the available parking range and the parking position based on the vehicle width and the distance between the zone lines 24. The parking position calculation unit 19 outputs information that indicates the calculated available parking range and parking position to the display image generation unit 20.

The parking position display processing apparatus 10 executes a process of step S14 after a process of step S13.

Note that in a case where the parking position calculation unit 19 acquires either one or both of the object information and the attribute information from the vehicle inside-outside state recognition unit 17, the parking position calculation unit 19 may acquire the detection information (vehicle inside-outside state information) from the vehicle inside-outside state recognition unit 17. Further, the parking position calculation unit 19 may acquire either one of or both of the object information and the attribute information from the object information storage unit 21-1 or the attribute information storage unit 21-2. In this case, because the vehicle inside-outside state recognition unit 17 and the parking position calculation unit 19 may be caused to act asynchronously, power consumption may be reduced.

In step S14, the display image generation unit 20 superimposes the detection information input from the vehicle inside-outside state recognition unit 17 and the parking position information input from the parking position calculation unit 19 on the image signal input from the image acquisition unit 16, thereby generates the image of the parking position display region 23, and causes the display 90 to display the generated image of the parking position display region 23. Subsequently, the process related to FIG. 5 is finished.

As described above, the parking position display processing apparatus 10 according to the first embodiment includes an image capturing unit (rear camera 12) that captures an image of a surrounding of the vehicle 11 and generates a captured image, the vehicle information acquisition unit 18 that acquires the vehicle information of the vehicle 11, a vehicle surrounding state recognition unit (vehicle inside-outside state recognition unit 17) that generates vehicle surrounding information which indicates a state of the surrounding of the vehicle 11 based on the captured image and the vehicle information, the parking position calculation unit 19 that calculates the planned parking position of the vehicle 11 based on the vehicle surrounding information and the vehicle information, a composite image generation unit (display image generation unit 20) that generates a composite image from an image which represents the planned parking position and an image which represents the state of the surrounding of the vehicle 11 in the planned parking position based on the planned parking position and the vehicle surrounding information, and a display unit (display 90) that displays the composite image.

Accordingly, convenience for the riding member in a case of parking the vehicle may be improved.

### Second Embodiment

In the first embodiment, a description is made about a case where only the rear camera 12 is included. In this case, although the situation on the outside in the rear of the vehicle 11 (surrounding environment) may be checked, surrounding environments in front, on the right, and on the left may not be checked. Thus, in the second embodiment, a description will be made about one example in which plural cameras are used instead of or in addition to the rear camera 12.

In such a manner, the surrounding environment of all the surroundings of the vehicle 11 may be checked, and which door of the vehicle 11 has to be used to get off the vehicle may in advance be checked.

Note that in the second embodiment, a description will be made while different portions from the first embodiment are focused.

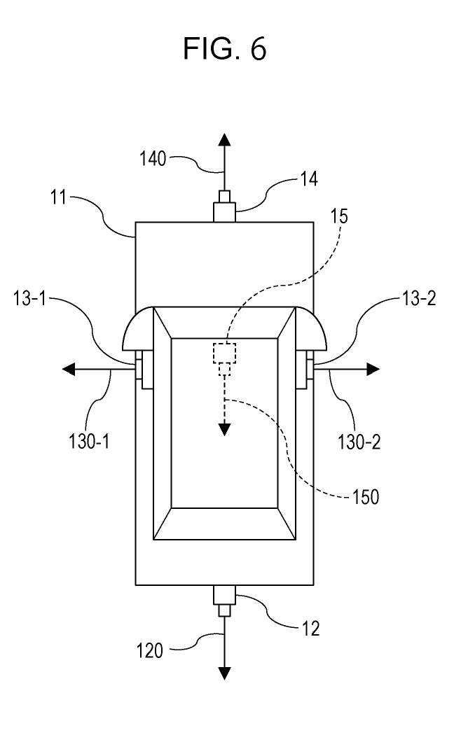

FIG. 6 is a bird's-eye diagram that illustrates the vehicle 11 according to the second embodiment of the present disclosure.

The vehicle 11 includes the rear camera 12, side cameras 13-1 and 13-2, a front camera 14, and a room camera 15. The other configurations are similar to the vehicle 11 and the parking position display processing system according to the first embodiment and will thus not be illustrated or described. In the following description, in a case where the side cameras 13-1 and 13-2 are not distinguished, the side camera will be referred to as side camera 13.

The side camera 13 photographs a side of the vehicle 11, that is, a space which a riding person (riding member) gets down to. The side camera 13 is desirably placed so as to be capable of photographing the side of the vehicle 11, that is, the space which the riding person (riding member) gets down to. The optical axes of the side cameras 13 will be denoted as optical axes 130-1 and 130-2.

The front camera 14 photographs the front of the vehicle 11 as seen from a driver seat. The front camera 14 is desirably placed so as to be capable of photographing a dead angle that is present in a lower portion in front of the vehicle 11 as seen from the driver seat. The optical axis of the front camera 14 will be denoted as optical axis 140.

The room camera 15 photographs the faces of all the riding persons (riding members) of the vehicle 11. The room camera 15 is desirably placed so as to be capable of photographing the faces of all the riding persons (riding members) of the vehicle 11. Here, the faces of all the riding members may be photographed by one camera, or the faces of all the riding members may be photographed by plural cameras. In this case, in a case where it is possible to photograph the faces of all the riding members, a wide-angle lens may be used, or a narrow-angle lens may be used. In this embodiment, a description will be made about one example in which one camera in which a wide-angle lens is installed is used as the room camera 15. The optical axis of the room camera 15 will be denoted as optical axis 150.

The side cameras 13, the front camera 14, and the room camera 15 are in similar configurations to the rear camera 12, and a description will thus not be made.

FIG. 7 is a schematic block diagram that illustrates one example of a function configuration of the parking position display processing apparatus 10 according to the second embodiment of the present disclosure.

The parking position display processing apparatus 10 is configured to include the image acquisition unit 16, the vehicle inside-outside state recognition unit 17, the vehicle information acquisition unit 18, the parking position calculation unit 19, the display image generation unit 20, the object information storage unit 21-1, the attribute information storage unit 21-2, and a getting-off position calculation unit 22.

The room camera 15 photographs an image of an inside of the vehicle (which will also be referred to as in-vehicle image). The room camera 15 outputs an image signal that represents the photographed in-vehicle image to the vehicle inside-outside state recognition unit 17.

In a case where the image signal that represents the in-vehicle image is input from the image acquisition unit 16, the vehicle inside-outside state recognition unit 17 executes a detection process of the face of the riding member in the in-vehicle image (which will also be referred to as face detection process) and calculates the position information (coordinate positions) of one or plural faces in the in-vehicle image and the features of one or plural faces in the in-vehicle image. The face detection process is a process of calculating the position information of the face by using a predetermined process (for example, the AdaBoost algorithm).

Note that the vehicle inside-outside state recognition unit 17 may use a detection method which detects the position information and the feature of the face from another image signal. Further, the vehicle inside-outside state recognition unit 17 may calculate the position information (coordinate positions) of one or plural faces in the in-vehicle image and body-build information that indicates the size of the body of each of the riding members in the in-vehicle image and may associate the pieces of body-build information of the riding members with the pieces of position information of the faces of the riding members. The body-build information may be calculated from the background difference between the in-vehicle images photographed in a certain frame and the next frame. Further, because the body-build information may differ depending on the riding position of the riding member, the pieces of body-build information that are calculated for the riding members are each divided by the sizes of the faces of the riding members, and the body-build information may thereby be normalized. Further, calculation of the body-build information for each of the riding members in the in-vehicle image is not limited to the above, but any method that is capable of calculation of the body-build of the riding member may be used. As described above, the position information of the face is associated with the body-build information, and the door opening amount that has to be secured in a case where the riding member gets off the vehicle may thereby be estimated from the body-build in a case of calculation of the opening amount of each of the doors of the vehicle 11, which will be described later. Thus, compared to a case where the door opening amount is calculated only from the feature of the face, calculation precision of the door opening amount may be enhanced.

The vehicle inside-outside state recognition unit 17 calculates the gravity center position of the face from the calculated position information of the face and calculates the number of persons who ride the vehicle based on the number of gravity center positions. Further, the vehicle inside-outside state recognition unit 17 converts the calculated gravity centers into the positions in an in-vehicle space based on the placement place of the room camera 15 and the direction of the optical axis 150 and thereby calculates the respective riding positions of the riding members in the vehicle 11. Note that instead of or in addition to calculating the number of persons who ride the vehicle by calculating the gravity center positions of the faces, the vehicle inside-outside state recognition unit 17 may calculates the number of persons who ride the vehicle by using various sensors 60-c (c is a predetermined integer that is equal to or more than one), which are capable of detecting presence of a person, such as a person detecting sensor, a pressure sensor, and an infrared sensor in each seat in the vehicle. In this case, the number of persons who ride the vehicle that is calculated by using the various sensors 60-c may be associated with the position information of the faces.

The vehicle inside-outside state recognition unit 17 generates two-dimensional face region information that includes the two-dimensional coordinates of a representative point (for example, the gravity center) in the region of the detected face (or person) and the two-dimensional coordinates of an upper end, a lower end, a left end, and a right end of the region of the detected face (or person). The vehicle inside-outside state recognition unit 17 executes an attribute estimation process for the two-dimensional coordinates of the representative points and the two-dimensional coordinates of the regions of the detected faces (or persons) in the generated two-dimensional face region information and calculates the ages of the respective faces. The vehicle inside-outside state recognition unit 17 causes the attribute information storage unit 21-2 to store the calculated ages of the respective faces.

Here, in the following description, information about the ages of the respective faces, information about the number of persons who ride the vehicle, and information about the riding positions may be referred to as riding member information.

In a case where the respective image signals are input from the cameras (the rear camera 12, the side cameras 13, and the front camera 14) placed on the outside of the vehicle 11, the vehicle inside-outside state recognition unit 17 executes an object detection process of detecting objects in the images represented by the image signals and calculates the respective position coordinates of the objects in the images as the position information. Further, the vehicle inside-outside state recognition unit 17 performs image processing by machine learning (for example, deep learning) or artificial intelligence for the respective position coordinates of the detected objects and calculates the heights of the objects. The vehicle inside-outside state recognition unit 17 causes the object information storage unit 21-1 to store the calculated heights of the respective objects.

The vehicle inside-outside state recognition unit 17 outputs the two-dimensional face region information, height information that indicates the heights of the objects, information that indicates the number of persons who ride the vehicle, the ages of the respective faces, and the detection information as the vehicle inside-outside state information to the parking position calculation unit 19 and the getting-off position calculation unit 22.

The parking position calculation unit 19 extracts the position information of the zone lines 24 as the object information from the detection information input from the vehicle inside-outside state recognition unit 17. The parking position calculation unit 19 calculates the distances between two neighboring zone lines 24 from the position coordinates of plural zone lines 24. The parking position calculation unit 19 calculates the available parking range 26 by multiplying the calculated distance between the zone lines 24 by the length of the zone line 24. Further, in a case where the position information of the object that is present in the calculated available parking range 26 is present, the parking position calculation unit 19 assesses the object that is present in the available parking range 26 as an obstacle. The parking position calculation unit 19 calculates the portion, from which the area of the obstacle which corresponds to the coordinate position of the object which corresponds to the assessed obstacle is omitted, as the parking position 27.

The parking position calculation unit 19 extracts the number of persons who ride the vehicle, the riding positions, and the ages of the faces from the vehicle inside-outside state information input from the vehicle inside-outside state recognition unit 17 and calculates the opening amounts of all the doors of the vehicle 11 based on presence or absence of the riding persons (riding members) of the vehicle 11 and the ages of the respective riding persons (riding members) of the vehicle 11. The opening amount of the door differs depending on the age of the riding person. Because a person who is less than 20 years old or 60 or more years old, for example, is not capable of adjusting the force level or has difficulty in adjustment of the force level in a case of opening the door, the opening amount of the door has to be made large. The opening amount of the door has to be set to the opening amount at which the door is fully opened, for example, to the maximum. As described above, the parking position calculation unit 19 refers to a table, in which the opening amount of the door is associated with the age or age group, about the opening amount of the door, for example, and calculates the opening amounts of all the doors of the vehicle 11.

Note that in a case where the vehicle inside-outside state recognition unit 17 calculates the body-build information that indicates the sizes of the bodies of the respective riding persons, the vehicle inside-outside state recognition unit 17 may calculate the body-build information of the riding persons (riding members) from the vehicle inside-outside state information and calculate the opening amounts of the doors from the ages of the riding persons and the body-build information. For example, three tables, in which the opening amount of the door is associated with each age or age group with respect to three kinds of body-build information (such as a large body-build case, a standard body-build case, and a small body-build case), are in advance created, and the door opening amount may be calculated by switching the table which is referred to in accordance with the calculated body-build information. For example, as for the body-build information, the body-build whose occurrence frequency is highest in each age or age group may be defined as a standard, a larger body-build than the standard body-build may be defined as a large body-build, and a smaller body-build than the standard body-build may be defined as a small body-build. A method of distinguishing the body-build information is not limited to the above, but any method may be used.

The parking position calculation unit 19 outputs the calculated planned parking position and information that indicates the opening amounts of the doors of the vehicle 11 in the planned parking position to the display image generation unit 20 and the getting-off position calculation unit 22.

Note that the parking position calculation unit 19 may arbitrarily set the opening amount of the door regardless of the age or age group or may set the opening amount of the door in accordance with the age, age group, sex, or the like.

The getting-off position calculation unit 22 extracts the number of persons who ride the vehicle, the riding positions, and the ages of the faces from the vehicle inside-outside state information input from the vehicle inside-outside state recognition unit 17 and extracts the opening amounts of the doors from the information that is input from the parking position calculation unit 19 and indicates the opening amounts of the doors. The getting-off position calculation unit 22 calculates all the getting-off positions for the doors of the vehicle 11 based on presence or absence of the riding persons (riding members) of the vehicle 11, the ages of the respective riding persons (riding members) of the vehicle 11, and the opening amounts of the respective doors of the vehicle 11. The getting-off position calculation unit 22 outputs information that indicates the calculated getting-off positions of the respective doors to the display image generation unit 20.

The display image generation unit 20 performs composition of the image signals of the rear camera 12, the side cameras 13, and the front camera 14, that is, the images by all external cameras of the vehicle and thereby generates a bird's-eye image (overhead image). Techniques in related art may be used for generation of the bird's-eye image.

The display image generation unit 20 acquires the parking position and the door opening amounts from the parking position calculation unit 19, superimposes door images in a state where the doors are opened in accordance with the respective opening amounts of the doors on the vehicle image in the planned parking position, and thereby generates the parking position image. The display image generation unit 20 superimposes the door images on the vehicle image in the planned parking position such that the door images overlap with the positions of the doors in the vehicle image in the planned parking position and thereby generates the parking position image as a bird's-eye image. The display image generation unit 20 acquires the getting-off positions included in the information that indicates the respective getting-off positions for the doors from the getting-off position calculation unit 22 and superimposes an image that represents the getting-off positions on the vehicle image in the bird's-eye image. The display image generation unit 20 causes the display 90 to display the generated bird's-eye image.

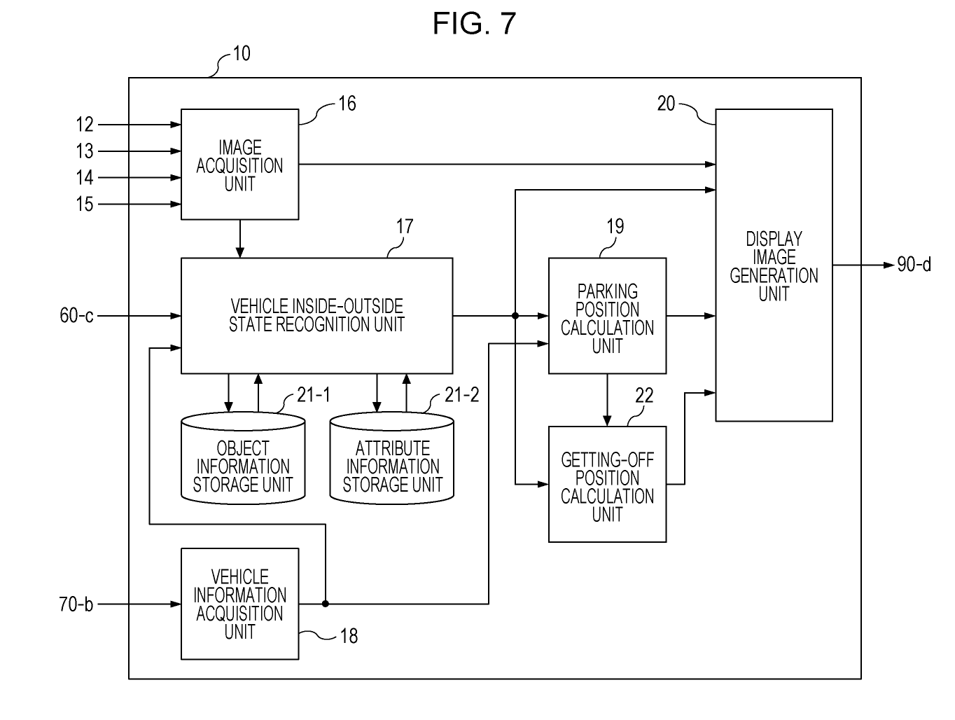

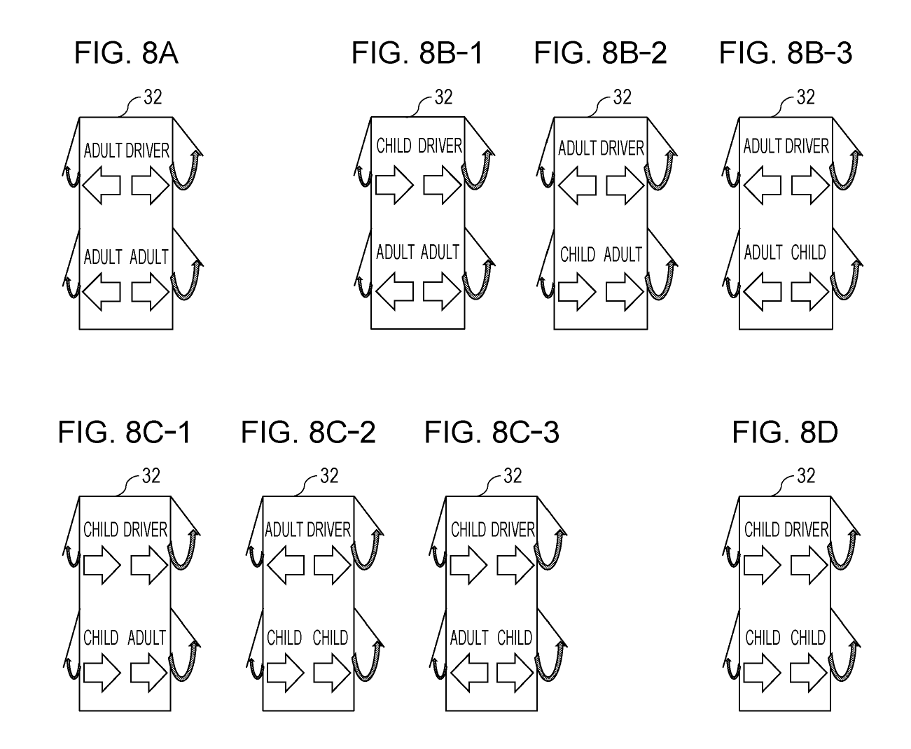

Here, a description will be made about one example in which the doors of the vehicle 11 are provided on both sides of the vehicle 11. Here, depending on the combination of the riding persons, a wider getting-off space in parking may be secured in a case where the riding persons get off the vehicle from the doors on one side of the vehicle 11 than a case where the riding persons get off the vehicle from the doors on both sides of the vehicle 11. Details will be described by using FIGS. 8A to 8D.

FIGS. 8A to 8D are explanatory diagrams that illustrate examples of the vehicle images 32 according to the second embodiment of the present disclosure.

The examples illustrated in FIGS. 8A to 8D are examples in which, as the riding members of the vehicle 11, three adults or children in addition to the driver ride the vehicle 11, that is, four riding members ride the vehicle 11. The vehicle images 32 illustrated in FIGS. 8A to 8D are displayed on the display 90 instead of the vehicle images 32 according to the first embodiment, which are illustrated in FIG. 3, for example.

FIG. 8A is one example of the vehicle image 32 that is displayed on the display 90 in a case where the driver and three adults ride the vehicle 11, FIG. 8B-1, FIG. 8B-2, FIG. 8B-3, FIG. 8C-1, FIG. 8C-2, and FIG. 8C-3 are examples of the vehicle images 32 that are displayed on the display 90 in cases where at least one adult and at least one child in addition to the driver ride the vehicle 11, and FIG. 8D is one example of the vehicle image 32 that is displayed on the display 90 in a case where the driver and three children ride the vehicle 11.

The vehicle image 32 is generated by the display image generation unit 20 based on the vehicle inside-outside state information and is displayed in the safety information display region 23A before the vehicle 11 is parked at the planned parking position. The riding persons of the vehicle 11 may check how much the respective opening amounts of the doors of the vehicle 11 are before the vehicle 11 is parked at the planned parking position.

Here, it is premised that not all the doors of the vehicle 11 may be fully opened due to an obstacle or the like in the available parking range of the vehicle 11. Further, the arrows in the vehicle 11 (in the rectangle) in each of the vehicle images indicate the directions of getting-off doors in getting off the vehicle, and the curved arrows (hatched arrows) indicates the respective opening amounts of the doors.

In FIG. 8A, it is premised that the adult on the rear right side of the driver is 60 or more years old and the adult on the left side of the driver and the adult on the rear left side of the driver are in their thirties. Here, the parking position calculation unit 19 generates the door images of the vehicle image 32 which indicate that a wide space is requested on the driver side, that is, the right side of the vehicle 11 and in which the opening amounts of the doors on the driver side are large. On the other hand, the parking position calculation unit 19 generates the door images of the vehicle image 32 which indicate that the space on the left side of the vehicle 11 is narrow and the maximum opening amount of the door is restricted, that is, attention has to be paid in a case of opening or closing the door and in which the opening amounts of the doors are small.

In such a manner, in a case where the riding persons get off the vehicle from the respective seats of the vehicle 11, before parking the vehicle 11, the riding persons may get off the vehicle while checking the door positions in getting off the vehicle, the respective opening amount of the doors, and the situations on the outside of the vehicle in the door positions of the doors that are opened in a case of getting off the vehicle, and the vehicle 11 may be parked in consideration of the opening amounts of the doors. Thus, convenience may be improved.

FIGS. 8B-1 to 8C-3 are examples of the vehicle images 32 that are displayed on the display 90 in a case where the driver, adults, and children get off the vehicle. A child is not capable of or has difficulty in adjusting the force level in a case of opening the door, and the door may contact with an obstacle around the vehicle 11. Thus, the getting-off position is displayed on the display 90 so that the child may get off from the door whose door opening amount is wider among plural doors. Accordingly, the possibility that the door of the vehicle 11 contacts with an obstacle in the vicinity may be decreased.

Further, FIG. 8D is a getting-off position display example that is displayed in a case where the driver and children get off the vehicle, and the getting-off position is displayed so that the children may get off from the doors whose door opening amounts are wider.

Here, in the examples illustrated in FIGS. 8A to 8D, a description is made only about the vehicle images 32. However, the parking position calculation unit 19 acquires the position information of an obstacle and the position information of the caution spot from the vehicle inside-outside state recognition unit 17 and emphatically displays the position of the obstacle and the position of the caution spot by frames, for example, and the display image generation unit 20 thereafter causes the display 90 to display the bird's-eye image generated.

Note that in the examples illustrated in FIGS. 8A to 8D, a description is made about a display example in which the driver, adults, and children get off the vehicle. However, the getting-off position may be displayed such that all the getting-off persons get off from the doors provided for the seats. In this case, because the room camera 15 is not requested, the cost for introduction of the parking position display processing apparatus 10 that includes the camera, the trouble for adjustment of the room camera 15, and so forth may be reduced.

Note that the bird's-eye image may be displayed on plural displays 90-d or may be displayed on one display. In addition, different images may be displayed in respective displays such as displaying the overhead diagram on a certain display and displaying a rear camera image on another display.

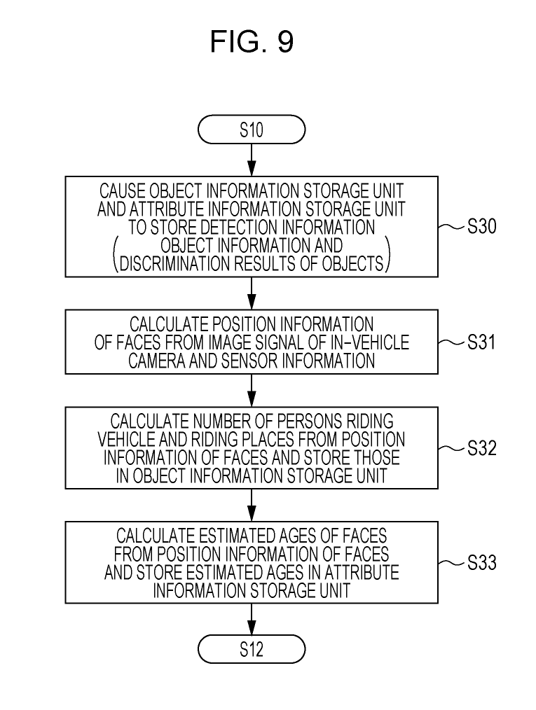

FIG. 9 is a flowchart that illustrates one example of a parking position display process according to the second embodiment of the present disclosure.

The parking position display process in FIG. 9 (processes of step S30 to step S33) is executed instead of the processes of step S11 and step S12 in the parking position display process illustrated in FIG. 5 after the process of step S10 and before the process of step S13.

In step S30, in a case where the respective image signals of the external cameras of the vehicle (the rear camera 12, the side cameras 13, and the front camera 14) are input from the image acquisition unit 16, the vehicle inside-outside state recognition unit 17 detects objects in the images represented by the image signals and causes the object information storage unit 21-1 to store the coordinate information (object information) of the detected objects. Further, the vehicle inside-outside state recognition unit 17 performs discrimination about what the detected objects are (discrimination among the objects) and causes the attribute information storage unit 21-2 to store the discrimination results of the objects (attribute information). The vehicle inside-outside state recognition unit 17 outputs the object information (the coordinate information of the objects) and the discrimination results of the objects as the detection information (which will also be referred to as vehicle inside-outside state information) to the parking position calculation unit 19, the display image generation unit 20, and the getting-off position calculation unit 22.

In step S31, the room camera 15 photographs an image of the inside of the vehicle (which will also be referred to as in-vehicle image). The room camera 15 outputs the image signal that represents the photographed in-vehicle image to the vehicle inside-outside state recognition unit 17.

In a case where the image signal that represents the in-vehicle image is input from the image acquisition unit 16, the vehicle inside-outside state recognition unit 17 executes the detection process of the face of the riding member in the in-vehicle image (which will also be referred to as face detection process) and calculates the position information (coordinate positions) of one or plural faces in the in-vehicle image and the features of one or plural faces in the in-vehicle image. The face detection process is a process of calculating the position information of the face by using a predetermined process (for example, the AdaBoost algorithm).

Note that the vehicle inside-outside state recognition unit 17 may use a detection method which detects the position information and the feature of the face from another image signal.

In step S32, the vehicle inside-outside state recognition unit 17 calculates the gravity center position of the face from the calculated position information of the face and calculates the number of persons who ride the vehicle based on the number of gravity center positions. Further, the vehicle inside-outside state recognition unit 17 converts the calculated gravity centers into the positions in the in-vehicle space based on the placement place of the room camera 15 and the direction of the optical axis 150 and thereby calculates the respective riding positions of the riding members in the vehicle 11. Note that instead of or in addition to calculating the number of persons who ride the vehicle by calculating the gravity center positions of the faces, the vehicle inside-outside state recognition unit 17 may calculates the number of persons who ride the vehicle by using various sensors 60-c (c is a predetermined integer that is equal to or more than one), which are capable of detecting presence of a person, such as a person detecting sensor, a pressure sensor, and an infrared sensor in each seat in the vehicle. In this case, the number of persons who ride the vehicle that is calculated by using the various sensors 60-c may be associated with the position information of the faces.

In step S33, the vehicle inside-outside state recognition unit 17 generates the two-dimensional face region information that includes the two-dimensional coordinates of the representative point (for example, the gravity center) in the region of the detected face (or person) and the two-dimensional coordinates of the upper end, the lower end, the left end, and the right end of the region of the detected face (or person). The vehicle inside-outside state recognition unit 17 executes the attribute estimation process for the two-dimensional coordinates of the representative points and the two-dimensional coordinates of the regions of the detected faces (or persons) in the generated two-dimensional face region information and calculates the ages of the respective faces. The vehicle inside-outside state recognition unit 17 causes the attribute information storage unit 21-2 to store the calculated ages of the respective faces.

Here, in the following description, the information about the ages of the respective faces, the information about the number of persons who ride the vehicle, and the information about the riding positions may be referred to as riding member information.

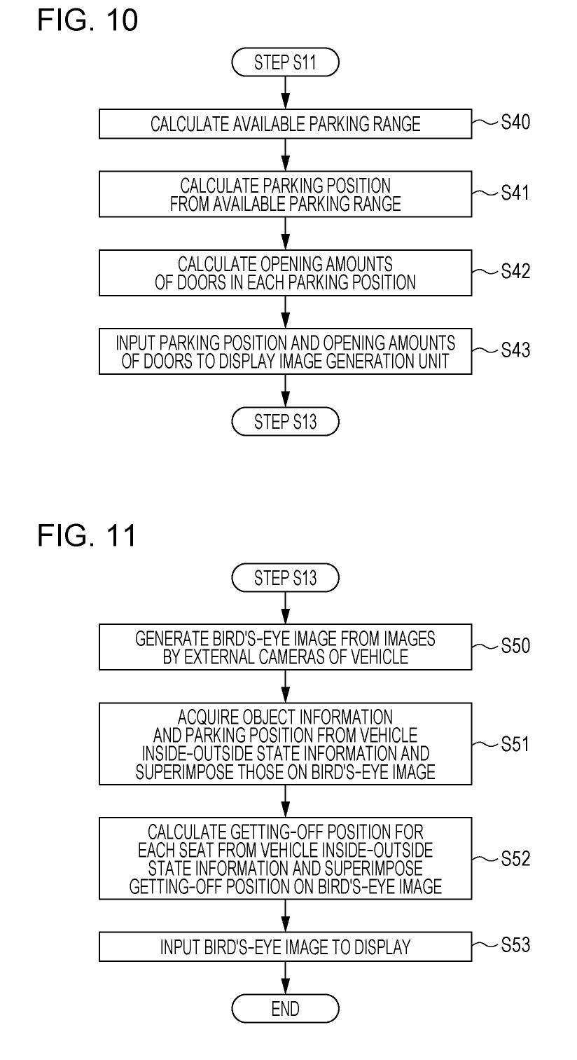

FIG. 10 is a flowchart that illustrates one example of the parking position display process according to the second embodiment of the present disclosure.

The parking position display process in FIG. 10 (processes of step S40 to step S43) is executed instead of the process of step S13 in the parking position display process illustrated in FIG. 5 after the process of step S12 and before the process of step S14.

In step S40, in a case where the respective image signals are input from the cameras (the rear camera 12, the side cameras 13, and the front camera 14) placed on the outside of the vehicle 11, the vehicle inside-outside state recognition unit 17 executes the object detection process of detecting objects in the images represented by the image signals and calculates the respective position coordinates of the objects in the images as the position information. Further, the vehicle inside-outside state recognition unit 17 performs image processing by machine learning (for example, deep learning) or artificial intelligence for the respective position coordinates of the detected objects and calculates the heights of the objects. The vehicle inside-outside state recognition unit 17 causes the object information storage unit 21-1 to store the calculated heights of the respective objects. The parking position calculation unit 19 extracts the position information of the zone lines 24 as the object information from the detection information input from the vehicle inside-outside state recognition unit 17. The parking position calculation unit 19 calculates the distances between two neighboring zone lines 24 from the position coordinates of plural zone lines 24. The parking position calculation unit 19 calculates the available parking range 26 by multiplying the calculated distance between the zone lines 24 by the length of the zone line 24.

In step S41, in a case where the position information of the object that is present in the calculated available parking range 26 is present, the parking position calculation unit 19 assesses the object that is present in the available parking range 26 as an obstacle. The parking position calculation unit 19 calculates the portion, from which the area of the obstacle which corresponds to the coordinate position of the object which corresponds to the assessed obstacle is omitted, as the parking position 27.

In step S42, the parking position calculation unit 19 extracts the number of persons who ride the vehicle, the riding positions, and the ages of the faces from the vehicle inside-outside state information input from the vehicle inside-outside state recognition unit 17 and calculates the opening amounts of all the doors of the vehicle 11 based on presence or absence of the riding persons (riding members) of the vehicle 11 and the ages of the respective riding persons (riding members) of the vehicle 11. The opening amount of the door differs depending on the age of the riding person. Because a person who is less than 20 years old or 60 or more years old, for example, is not capable of adjusting the force level or has difficulty in adjustment of the force level in a case of opening the door, the opening amount of the door has to be made large. The opening amount of the door has to be set to the opening amount at which the door is fully opened, for example, to the maximum. As described above, the parking position calculation unit 19 refers to a table, in which the opening amount of the door is associated with each age or age group, about the opening amount of the door, for example, and calculates the opening amounts of all the doors of the vehicle 11.

In step S43, the parking position calculation unit 19 outputs the calculated planned parking position and the information that indicates the opening amounts of the doors of the vehicle 11 in the planned parking position to the display image generation unit 20 and the getting-off position calculation unit 22.

Note that the parking position calculation unit 19 may arbitrarily set the opening amount of the door regardless of the age or age group or may set the opening amount of the door in accordance with the age, age group, sex, or the like.

Note that in step S40, the vehicle inside-outside state recognition unit 17 may calculate the body-build information that indicates the size of the body of each of the riding members in the in-vehicle image and may associate the pieces of body-build information with the pieces of position information of the faces of the riding members. In this case, in step S42, the vehicle inside-outside state recognition unit 17 may calculate the body-build information of the riding person from the vehicle inside-outside state information and calculate the opening amount of the door from the age of the riding person and the body-build information. For example, three tables, in which the opening amount of the door is associated with each age or age group with respect to three kinds of body-build information (a large body-build case, a standard body-build case, and a small body-build case), are in advance created, and the door opening amount may be calculated by switching the table which is referred to in accordance with the calculated body-build information. For example, as for the body-build information, the body-build whose occurrence frequency is highest in each age or age group may be defined as a standard, a larger body-build than the standard body-build may be defined as a large body-build, and a smaller body-build than the standard body-build may be defined as a small body-build. A method of distinguishing the body-build information is not limited to the above, but any method may be used.

FIG. 11 is a flowchart that illustrates one example of the parking position display process according to the second embodiment of the present disclosure.

The parking position display process in FIG. 11 (processes of step S50 to step S53) is executed instead of the process of step S14 in the parking position display process illustrated in FIG. 5 after the process of step S13.

In step S50, the display image generation unit 20 performs composition of the image signals of the rear camera 12, the side cameras 13, and the front camera 14, that is, the images by all the external cameras of the vehicle and thereby generates the bird's-eye image (overhead image). Techniques in related art may be used for generation of the bird's-eye image.

In step S51, the display image generation unit 20 acquires the parking position and the door opening amounts from the parking position calculation unit 19, superimposes door images in a state where the doors are opened in accordance with the respective opening amounts of the doors on the vehicle image in the planned parking position, and thereby generates the parking position image. The display image generation unit 20 superimposes the door images on the vehicle image in the planned parking position such that the door images overlap with the positions of the doors in the vehicle image in the planned parking position and thereby generates the parking position image as the bird's-eye image. In step S52, the display image generation unit 20 superimposes the image that indicates the getting-off position on the vehicle image in the bird's-eye image based on the getting-off position acquired from the getting-off position calculation unit 22.

In step S53, the display image generation unit 20 causes the display 90 to display the generated bird's-eye image.

As described above, the parking position display processing apparatus 10 according to the second embodiment includes the image capturing unit (rear camera 12) that captures an image of a surrounding of the vehicle 11 and generates a captured image, the vehicle information acquisition unit 18 that acquires the vehicle information of the vehicle 11, the vehicle surrounding state recognition unit (vehicle inside-outside state recognition unit 17) that generates the vehicle surrounding information which indicates the state of the surrounding of the vehicle 11 based on the captured image and the vehicle information, the parking position calculation unit 19 that calculates the planned parking position of the vehicle 11 based on the vehicle surrounding information and the vehicle information, the getting-off position calculation unit 22 that calculates the getting-off position from the vehicle 11, the composite image generation unit (display image generation unit 20) that generates the composite image from an image which represents the planned parking position, an image which represents the state of the surrounding of the vehicle 11 in the planned parking position, and an image which represents the getting-off position based on the planned parking position and the vehicle surrounding information, and the display unit (display 90) that displays the composite image.

Accordingly, convenience for the riding member in a case of parking the vehicle may be improved.

### Third Embodiment

In a third embodiment, a description will be made about one example in which in a case where the riding person gets off the vehicle 11, a check is enabled to be made, before the door is opened, whether an obstacle is present in a working range of the door for getting off the vehicle or whether the working range of the door is the caution spot in a state where the riding person may not get off the vehicle (for example, a state where a water puddle or mud is present, a state where a ground surface is narrow due to steps or the like (a state where the footing is unsuitable (not good)), a state where an approacher such as a person, a bicycle, a car, or a motorcycle is present, or the like).

Specifically, in a case where the riding person gets off the vehicle 11, the riding person may not check the state of a landing surface in getting off the vehicle due to the dead angle by the door of the vehicle 11. Hypothetically, in a case where the riding person of the vehicle 11 checks the landing surface, the riding person has to predict the getting-off position before the vehicle 11 is parked at the parking position and to keep checking the state of the landing surface through a window of the vehicle 11. In addition, because a side mirror is not provided in a case of a rear seat, the riding person has to open the door after performing a direct visual checking about whether or not an approaching object such as a car, a motorcycle, a bicycle, a person, or an animal from the front and rear of the vehicle 11 is present.

However, in order to check the approaching object from the front or rear of the vehicle 11, the riding person of the rear seat has to approaches his/her face toward the window of the door and to thereby check the front or rear of the vehicle 11 because there are many articles such as the riding person of a front seat, a headrest of the front seat, and a frame or a pillar of the door, which block the vision of the riding person of the rear seat.

In addition, because performing such checking work at each time of getting off the vehicle is inconvenient, there is a concern that the check is not performed. Further, a child may open the door without performing the check.

Thus, in this embodiment, a description will be made about one example in which a state (surrounding environment) on the outside of the vehicle is in advance displayed in a case where the riding person gets off the vehicle 11 and the riding person may easily and safely open the door and get off the vehicle.

In such a manner, the surrounding environment of all the surroundings of the vehicle 11 may be checked before the door of the vehicle 11 is opened, and which door of the vehicle 11 has to be used to get off the vehicle may in advance be checked.

Note that in the third embodiment, a description will be made while different portions from the second embodiment are focused.

Here, compared to the parking position display processing apparatus 10 according to the second embodiment, a configuration of the parking position display processing apparatus 10 according to the third embodiment is different in a point that the parking position calculation unit 19 according to the third embodiment calculates the opening amounts of the door in plural phases and in a point that the display image generation unit 20 according to the third embodiment generates silhouette images that correspond to the opening amounts of the door in the plural phases. The others are similar to the second embodiment and will thus not be illustrated or described.

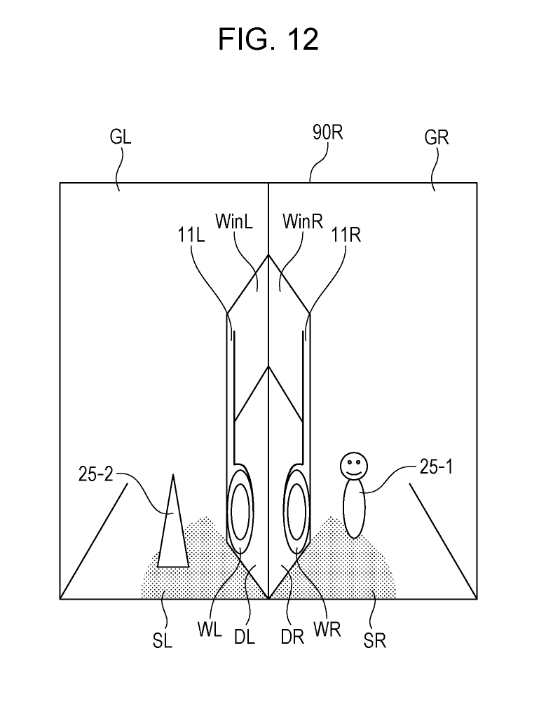

FIG. 12 is an explanatory diagram that illustrates one example of a display image according to the third embodiment of the present disclosure.

The example illustrated in FIG. 12 includes a vehicle left-side image GL based on an image photographed by the side camera 13-2 and a vehicle right-side image GR based on an image photographed by the side camera 13-1.

A vehicle left-side image is an image that results from conversion of an image, in which the side camera 13-2 photographs a left side of the vehicle 11 with respect to the vehicle 11 on the road, into an image along the direction from the front to the rear of the vehicle 11 and is displayed as the vehicle left-side image GL on the display 90-d. A vehicle right-side image is an image that results from conversion of an image, in which the side camera 13-1 photographs a right side of the vehicle 11 with respect to the vehicle 11 on the road, into an image along the direction from the front to the rear of the vehicle 11 and is displayed as the vehicle right-side image GR on the display 90-d.

Here, the display 90-d (d is an arbitrary integer that is equal to or more than one) includes a flip-down monitor that is arranged on a ceiling of the vehicle 11 such that the flip-down monitor is capable of being checked at the rear seat of the vehicle 11, for example. That is, the vehicle 11 includes plural displays 90-d. In the following description, the display that is described in the first embodiment and the second embodiment and is capable of being checked by the driver will be referred to as display 90F, and the display that is capable of being checked at the rear seat will be referred to as display 90R. Further, in a case where either one of the display 90F and the display 90R is indicated, the display may be referred to as display 90. The display 90F and the display 90R are included in the displays 90-d.

The vehicle left-side image GL includes a vehicle body 11L on the left side of the vehicle 11, a left window WinL, a left tire WL, a left getting-off space SL, a left rear door DL, and an obstacle 25-2. The vehicle right-side image GR includes a vehicle body 11R on the right side of the vehicle 11, a right window WinR, a right tire WR, a right getting-off space SR, a right rear door DR, and an approacher 25-1.

As illustrated in the vehicle left-side image GL, the obstacle 25-2 is present in front of the left rear door DL. In a case where the left rear door DL is opened without any preparation, the left rear door DL contacts with the obstacle 25-2, the left rear door DL does not open, and further the obstacle 25-2 or the vehicle 11 is possibly damaged. The getting-off person checks the vehicle left-side image GL in getting-off the vehicle and is thereby enabled to check a fact that the obstacle 25-2 is present before opening the left rear door DL.

In addition, in a case where the left getting-off space SL between the obstacle 25-2 and the vehicle 11 may be checked, the getting-off person slowly opens the left rear door DL while watching the vehicle left-side image GL and may thereby open the door while checking the opening amount of the left rear door DL that is being opened by the vehicle left-side image GL. Thus, the getting-off person may attempt to get off the vehicle without causing the left rear door DL to contact with the obstacle 25-2.

Further, as illustrated in the vehicle right-side image GR, a person (who will also be referred to as approacher) 25-1 who approaches the right rear door DR is present. In a case where the right rear door DR is opened without preparation, there is a risk that the right rear door DR contacts with the approacher 25-1 and the approacher 25-1 may thereby be injured.

The getting-off person checks the vehicle right-side image GR in getting-off the vehicle and is thereby enabled to check a fact that the approacher 25-1 is present before opening the right rear door DR.

Further, the getting-off person is enabled to open the door and safely get off the vehicle after checking from the vehicle right-side image GR that the approacher 25-1 passes by.

Note that the display 90R is not limited to a flip-down monitor but may be a display that is mounted on a rear side of the headrest of the front seat, may be a display that is set to an arm or the like which is fixed to the front seat, or may be a display that is placed in the front seat such that the driver or the like is capable of checking the display.

Note that a description is made about one example of an outside situation of a surrounding of a rear door of the vehicle 11. However, embodiments are not limited to this, but application may be performed for a case of getting off the vehicle from the front seat.

The outside situation of the vehicle 11 for the front seat may be displayed on the display 90F, for example, a display such as a display of a car navigation system or an electronic mirror that is used as a rear-view mirror or a side mirror.

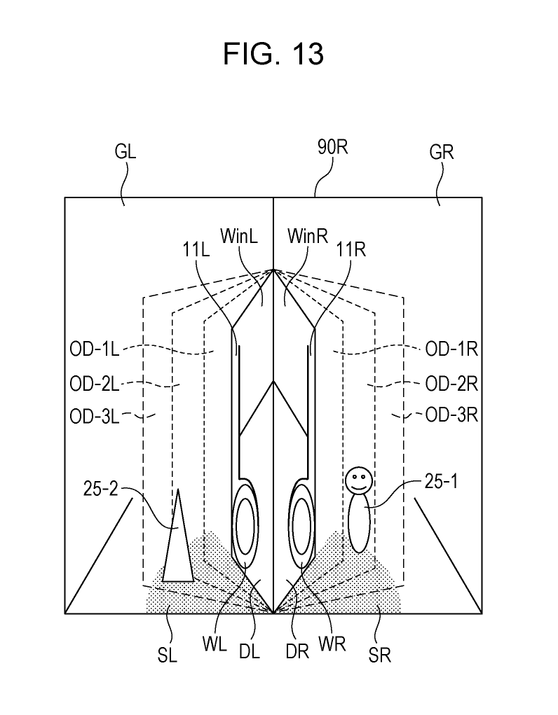

FIG. 13 is an explanatory diagram that illustrates one example of an image that illustrates the opening amount of the door of the vehicle 11 according to the third embodiment of the present disclosure.

The example illustrated in FIG. 13 is one example in which superimposition display of the images that represent the door opening amounts of the left rear door DL and the door opening amounts of the right rear door DR is performed on the display image illustrated in FIG. 12.

Here, elements that are common between FIG. 12 and FIG. 13 are provided with the same reference characters, and a description will not be made. In FIG. 13, a description will mainly be made about different portions from FIG. 12.

In the vehicle left-side image GL, in order to indicate at how much opening amount of the door the left rear door DL contacts with the obstacle 25-2, by the opening amounts of the door in plural phases, for example, three phases, silhouette images OD-1L, OD-2L, and OD-3L of the left rear door DL that correspond to the respective opening amounts of the door are displayed.

For example, the vehicle left-side image GL represents a case where the obstacle 25-2 is present in the position in which the left rear door DL is opened to the silhouette image OD-3L, that is, the opening amount in the third phase or more. That is, the example illustrated in FIG. 13 indicates that the left rear door DL may be opened to the opening amount of the door in the second phase and the left rear door DL contacts with the obstacle 25-2 at the opening amount of the door in the third phase or more.

The riding person of the vehicle 11 checks the display 90R while keeping riding the vehicle 11 and may thereby check whether or not an obstacle is present and how much the left rear door DL may be opened before opening the left rear door DL.

Further, the opening amount of the door that is requested for riding and getting off of the getting-off person is in advance set, and whether the getting-off person may get off the vehicle without contact with the obstacle 25-2 even in a case where the getting-off person opens the left rear door DL may thereby be checked only by watching the display image. Thus, convenience may be improved.

In the vehicle right-side image GR, in order to indicate at how much opening amount the right rear door DR contacts with the approacher 25-1, by the opening amounts of the door in plural phases, for example, three phases, silhouette images OD-1R, OD-2R, and OD-3R of the right rear door DR that correspond to the respective opening amounts of the door are displayed.

For example, the vehicle right-side image GR represents a case where the approacher 25-1 is present in the position in which the right rear door DR is opened to the silhouette image OD-2R, that is, the opening amount of the door in the second phase or more. That is, the example illustrated in FIG. 13 indicates that the right rear door DR may be opened to the opening amount of the door in the first phase and the right rear door DR contacts with the approacher 25-1 at the opening amount of the door in the second phase or more.

The riding person of the vehicle 11 checks the display 90R while keeping riding the vehicle 11 and may thereby check whether or not an approacher is present and how much the right rear door DR may be opened before opening the right rear door DR.

Note that in a case where the approacher 25-1 is moving, because the position of the approacher is different between the state where the getting-off person watches the vehicle right-side image GR in a case where the vehicle 11 stops and the state where the right rear door DR is opened, the door may not necessarily safely be opened. Thus, the getting-off person desirably carefully opens the right rear door DR while performing a check by the display 90R. In such a manner, an accident may be inhibited.

Note that the opening amounts of the doors may be in one phase or in plural phases such as two phases or four phases or more. Further, the number of phases of the opening amounts of the doors may be set in accordance with the size of the vehicle body of the vehicle 11 or the size of the getting-off space.

Note that the parking position calculation unit 19 may senses the situation of the outside of the vehicle 11 and may thereby calculate and use the opening amount of the door of the vehicle 11 at each time in a range in which the position of an obstacle or an obstacle or approacher such as a wall, a neighboring vehicle, an approaching person, or a vehicle does not collide with the door of the vehicle 11. Further, the parking position calculation unit 19 may set the number of phases of the opening amount of the door to one or plural phases in accordance with the calculated opening amount of the door of the vehicle 11.

Note that the opening amount of the door may be set such that the opening amount becomes larger by the same angle in each phase or may be set such that the angle becomes different in each phase.

Note that in a case where the opening amount of the door of the vehicle 11 that is calculated by the parking position calculation unit 19 is smaller than the width of the body of the getting-off person, the display image generation unit 20 may generate the silhouette image in one phase or may not generate the silhouette image. In those cases, because the getting-off person may know the position in which the door of the vehicle 11 contacts with the obstacle or approacher, a collision between the door of the vehicle 11 and the obstacle may be avoided, and the getting-off person may be advised that the getting-off person is requested to get off the vehicle from the other door.

Note that in a case where the opening amount of the door of the vehicle 11 that is calculated by the parking position calculation unit 19 is smaller than the width of the body of the getting-off person, the display image generation unit 20 may set the silhouette image in one phase or two phases. In a case where one phase is set, the getting-off person may get off the vehicle without colliding the door with the obstacle. Further, two phases are set, and the door may thereby be opened gradually while the present position of the door and the region of the opening amount of the door are checked. Thus, the getting-off person may get off the vehicle safely and at ease.

Note that in a case where the opening amount of the door of the vehicle 11 that is calculated by the parking position calculation unit 19 is larger than the width of the body of the getting-off person, the display image generation unit 20 may set two phases or more as the regions close to the region in which the door collides with the obstacle. In this case, in a case where the opening amount of the door becomes large (such as a case where no obstacle is present or a case where the distance between the obstacle and the subject vehicle is sufficiently long), the number of phases of the opening amount of the door increases, and it becomes difficult to see a safety information display region. However, for example, because three phases are set and the door opening for one phase thereby becomes large, the number of phases in which the getting-off person carefully opens the door decreases in a case where the getting-off person opens the door. Thus, the door may largely be opened quickly and at once, and the getting-off person may smoothly get off the vehicle.

Note that a method of calculating the opening amount of the door in accordance with the position of an obstacle is not limited to the above method, but any method may be used as long as it is possible to change the opening amount of the door for each of the doors in accordance with the position of an obstacle.

Further, a description is made about a case where the silhouette image that corresponds to the opening amount of the door is displayed by broken lines. However, in order to easily understand the positional relationship between an obstacle and the door, the silhouette images may be generated by using different colors in accordance with the opening amount of each of the doors, or the silhouette images may be generated by translucent door images. As long as the display method may clearly distinguish the positional relationship between the position in which the door is opened and an obstacle such as drawing a borderline of the opening amount of the door on the landing surface or displaying the silhouette images in different colors for the regions of the opening amounts of the respective doors on the landing surface, any silhouette image may be displayed.

In addition, in accordance with the opening amount of the door, the present position of the door may be emphatically displayed (such as making lines bolder or changing colors) compared to the other silhouette image.

Further, the silhouette image that represents the opening amount of the door may be displayed as a longer door than a rear end of the vehicle 11.

Accordingly, it becomes easy to understand the positional relationship between an obstacle or approacher that approaches from the rear of the vehicle and the subject vehicle, and it thereby becomes easy to predict how much the door is capable of being opened (or is allowed to be opened). Further, the silhouette image is displayed as a long door, and a determination may thereby immediately be made about at which opening amount of the door the door contacts with the obstacle even the obstacle is a little distant from the vehicle 11.

Note that the width of the body of the getting-off person may be displayed together with the silhouette image that represents the opening amount of the door.

Accordingly, in a case where the getting-off person gets off the vehicle, the getting-off person may in advance know how much the door has to be opened to get off the vehicle.

As described above, the parking position display processing apparatus 10 according to the third embodiment includes the image capturing unit (rear camera 12) that captures an image of a surrounding of the vehicle 11 and generates a captured image, the vehicle information acquisition unit 18 that acquires the vehicle information of the vehicle 11, the vehicle surrounding state recognition unit (vehicle inside-outside state recognition unit 17) that generates the vehicle surrounding information which indicates the state of the surrounding of the vehicle 11 based on the captured image and the vehicle information, the parking position calculation unit 19 that calculates the planned parking position of the vehicle 11 based on the vehicle surrounding information and the vehicle information, the composite image generation unit (display image generation unit 20) that generates the composite image from an image which represents the planned parking position and an image which represents the state of the surrounding of the vehicle 11 in the planned parking position based on the planned parking position and the vehicle surrounding information, and the display unit (display 90) that displays the composite image.

Accordingly, convenience for the riding member in a case of parking the vehicle may be improved.

### Fourth Embodiment

In a fourth embodiment, a description will be made about one example in which the display image that is displayed on the display 90R in the third embodiment is displayed on a display on the inside of the door of the vehicle 11 or a window of the vehicle 11.

Here, the parking position display processing apparatus 10 according to the fourth embodiment is similar to the parking position display processing apparatus 10 according to the third embodiment and will thus not be illustrated or described.

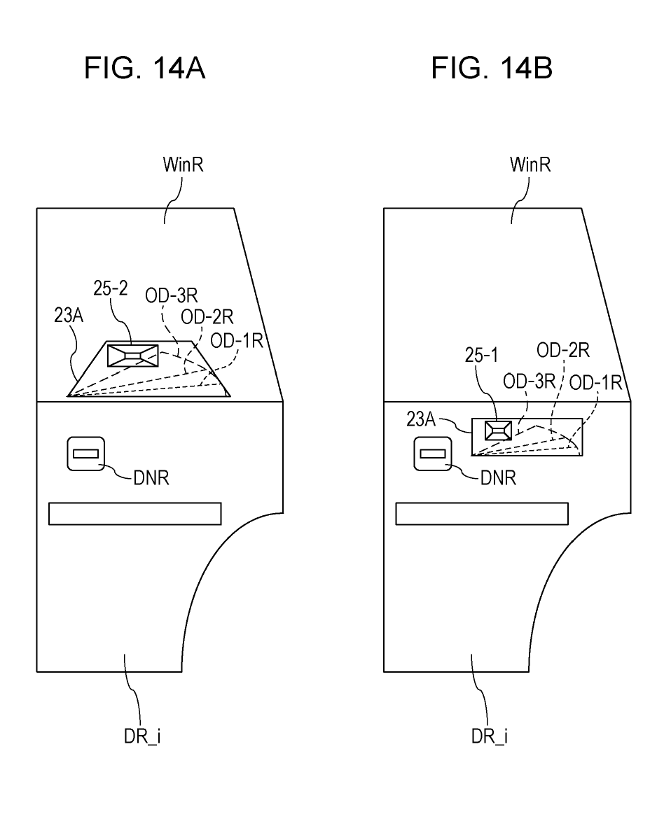

FIGS. 14A and 14B are explanatory diagrams that illustrate examples of the display images according to the fourth embodiment of the present disclosure.

The examples illustrated in FIGS. 14A and 14B are examples where the display 90R is provided on the inside of the door of the vehicle 11, for example, the window or the door, and performs display.

As the display that performs display on the window of the vehicle 11, a thin display device such as a liquid crystal display or an organic display on the window may be used, or a display in which a bendable liquid crystal sheet or the like is attached to the window may be used. In a case where the liquid crystal sheet is used, display may be performed with external light as a backlight without providing a backlight. In this case, a case where the window may not be opened due to the thickness of the display may be inhibited, and the viewability of the window may be maintained.

Note that although not limited to the liquid crystal sheet, the display that is set for a window region may be an organic EL display, or any display may be used as long as the display device is thin and bendable.

The display on the inside of the window about a vehicle outside state, which is illustrated in FIG. 14A, illustrates a case where the parking position calculation unit 19 converts an image by the side camera 13 as the vehicle outside state into a bird's-eye image as seen from above the vehicle 11 and causes the display 90F in a region of the window on the inside of the door to display the bird's-eye image. Accordingly, the getting-off person may check whether there is an obstacle like viewing the getting-off space that becomes a dead angle due to the door and is close to the vehicle 11 (landing surface) through the window.

In the display on the inside of the window about the vehicle outside state, which is illustrated in FIG. 14A, the vehicle outside state is displayed as the bird's-eye image in the safety information display region 23A. Similarly to FIG. 12 and FIG. 13, the opening amount of the door may be displayed by the silhouette image. The display on the inside of the window about the vehicle outside state, which is illustrated in FIG. 14A, illustrates that the obstacle 25-2 is present in the region OD-3R of the opening amount of the door in the third phase, and the getting-off person may take a glance about a fact that the door is capable of being opened to the opening amount of the door in the second phase in a case where the getting-off person opens the door by pulling a door release lever DNR.

As the display that is displayed on the inside of the door, a liquid crystal display or an organic EL display is desirably used. In such a manner, the viewability of the window may be maintained, and safety information may be presented to the riding person.

Note that as the display that is displayed on the inside of the door, a liquid crystal sheet may be used. In this case, a backlight may be provided.

Note that the display image that is displayed on the inside of the door, which is illustrated in FIG. 14B, is similar to the display image that is displayed on the window, which is illustrated in FIG. 14A. Thus, the same reference characters are provided, and a description will not be made.

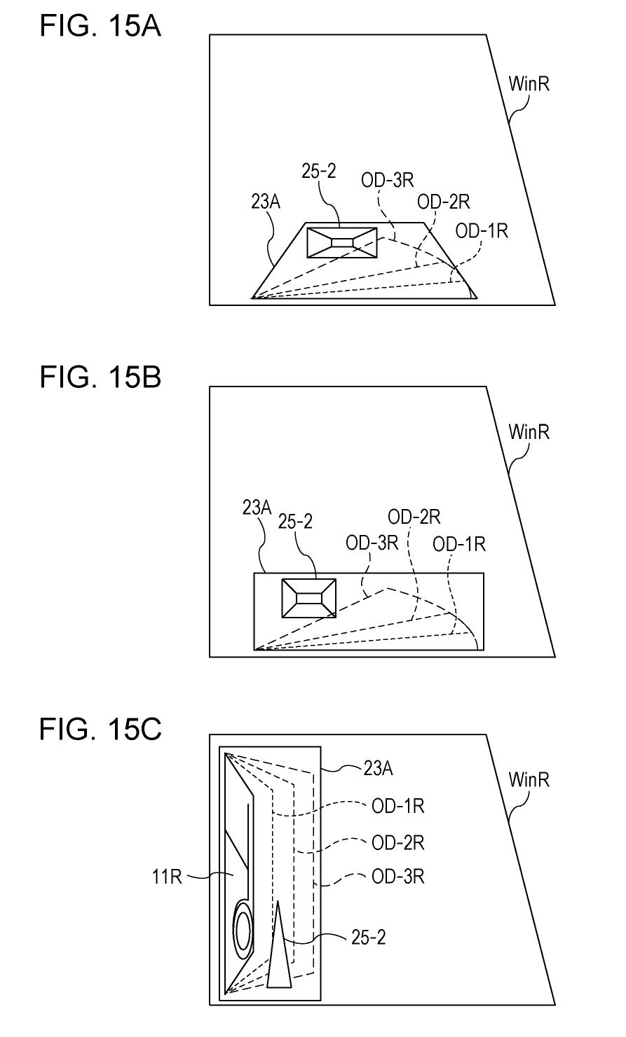

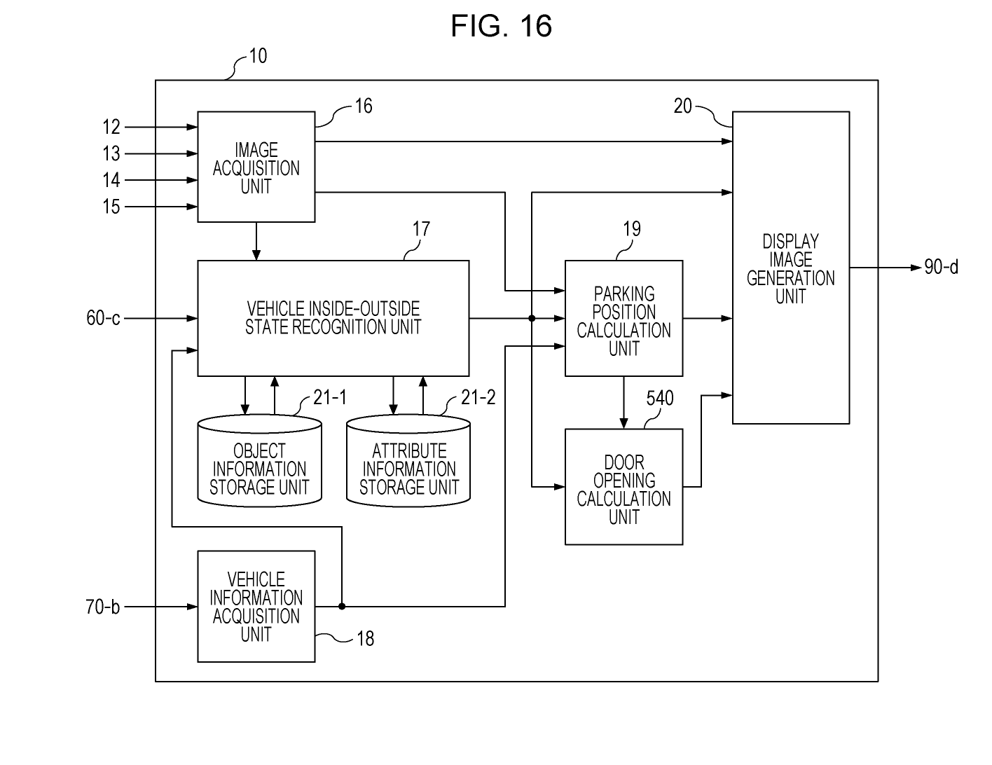

Note that a viewpoint position of the bird's eye image that is displayed on the display 90R in the region of the window on the inside of the door may be a viewpoint position right above the vehicle 11 (a viewpoint position for looking down toward the road in the vertical direction with respect to the vehicle 11) or may be a viewpoint position that is inclined at a prescribed angle, for example, 45 degrees from a viewpoint right above the vehicle 11. Details will be described with reference to FIGS. 15A to 15C.

FIGS. 15A to 15C are explanatory diagrams that illustrate examples of the display images according to the fourth embodiment of the present disclosure.

The display image (bird's-eye image) that is illustrated in FIG. 15A and is displayed on the display 90R on the inside of the window is one example in which the bird's-eye image, in which a position inclined from an upper side of the vehicle 11 toward the vehicle 11 side (for example, a position at 45 degrees from the vertical direction with respect to the vehicle 11) is set as the viewpoint position, is displayed on the display 90R on the inside of the window such that the getting-off person may naturally watch the getting-off space on the outside of the door through the window of the seat of the vehicle 11.

In the display image (bird's-eye image) that is illustrated in FIG. 15A and is displayed on the display 90R on the inside of the window, similarly to examples of the display images illustrated in FIGS. 14A and 14B, the obstacle is present in the region of the opening amount OD-3R of the door in the third phase.

In this case, the display image generation unit 20 generates the bird's-eye image that looks down from the viewpoint position which is inclined at a prescribed angle from the vertical direction.

As described above, the bird's-eye image in which the viewpoint position is changed is generated, and the getting-off person may at a glance check that the door of the vehicle 11 may be opened to the opening amount OD-2R of the door in the second phase. Further, display (safety information display) of the bird's-eye image that obliquely (an angle of 45 degrees) looks down is performed, and a dead angle region on the outside of the door may thereby be checked from the inside of the door without a door operation. Thus, the getting-off person may instinctively know the position of an obstacle.

The display image (bird's-eye image) that is illustrated in FIG. 15B and is displayed on the display 90R on the inside of the window is one example in which the bird's-eye image, which looks down from a viewpoint position substantially right above the vehicle 11 (an upper position of the vehicle 11), is displayed on the display 90R on the inside of the window.

In this case, the display image generation unit 20 generates the bird's-eye image that looks down from the viewpoint position in the vertical direction with respect to the vehicle 11.

In such a manner, occurrence of distortion of the display image may be inhibited. Further, because a regular distance relationship is provided between the vehicle 11 and the obstacle, the positional relationship between the vehicle 11 and the obstacle may be known by an actual sense of distance.

The display image (bird's-eye image) that is illustrated in FIG. 15C and is displayed on the display 90R on the inside of the window is one example in which the display image illustrated in FIG. 13 and FIGS. 14A and 14B is displayed by moving the display image toward an open-close axis side of a right rear door DR_i.

In the display image (bird's-eye image) that is illustrated in FIG. 15C and is displayed on the display 90R on the inside of the window illustrates a case where the obstacle is present in the region of a door opening amount 3.

In this case, the display 90R may be provided in a prescribed region of the window of the vehicle 11, for example, in the region illustrated in FIG. 15C, and the display image generation unit 20 may generate the vehicle right-side image GR similarly to the third embodiment and cause the display 90R to display the vehicle right-side image GR.

In such a manner, the getting-off person who rides on a right side of the rear seat of the vehicle 11 may check presence or absence of an obstacle or an approacher from the rear by the display image as the driver checks presence or absence of an obstacle or an approacher from the rear by the side mirror. That is, the getting-off person (riding member) may check the state on the outside of the vehicle similarly to a case where a door mirror for the rear seat is placed.

Note that in order to cause an actual axis of the door to substantially match an axis of the door on the safety information display, mirrored display of a photographed image by the side camera 13 is performed. However, an image photographed by the side camera 13-2 may be displayed without any change.

Accordingly, because an image on the right side of the vehicle 11 is displayed, the positional relationship particularly with a person who approaches from the rear of the vehicle 11 or another vehicle that approaches from the rear of the vehicle 11 may easily be known.

Note that in the above description, superimposition display of the silhouette images of the opening amounts of the door is performed on the safety information display region 23A, and the getting-off person adjusts the actual opening amount of the door to the opening amount close to the silhouette image of the opening amount of the door, which includes the obstacle, based on the display. However, embodiments are not limited to this. For example, the parking position display processing apparatus 10 may calculate the distance between the obstacle and the actual opening amount of the door from the bird's-eye image or the like and, in a case where the door approaches the obstacle (the distance between the door and the obstacle becomes a prescribed distance or less), may perform a notification by adding a force in a door opening direction (for example, adding a force so that it becomes difficult to open the door) or the like by an actuator or the like that is placed in an axial portion of the door or may notify the getting-off person of adjacency to the obstacle by sound or display. Adding a force that is mentioned here may be making it difficult to open the door when the door is opened in order to restrict the opening amount of the door or may be performing control such that it becomes difficult or unfeasible to open the door.

Further, the notification of the adjacency to the obstacle or the like by sound or display may be a gradual notification. For example, sound may be made in a case where the door approaches the obstacle, or the notification may gradually be performed by making the sound louder or changing the tone color as the door approaches the obstacle more in a case where the door approaches the obstacle. In such a manner, the getting-off person may recognize the distance between the obstacle and the door by the visual sense or the auditory sense.

As described above, the parking position display processing apparatus 10 according to the fourth embodiment includes the image capturing unit (rear camera 12) that captures an image of a surrounding of the vehicle 11 and generates a captured image, the vehicle information acquisition unit 18 that acquires the vehicle information of the vehicle 11, the vehicle surrounding state recognition unit (vehicle inside-outside state recognition unit 17) that generates the vehicle surrounding information which indicates the state of the surrounding of the vehicle 11 based on the captured image and the vehicle information, the parking position calculation unit 19 that calculates the planned parking position of the vehicle 11 based on the vehicle surrounding information and the vehicle information, the composite image generation unit (display image generation unit 20) that generates the composite image from an image which represents the planned parking position and an image which represents the state of the surrounding of the vehicle 11 in the planned parking position based on the planned parking position and the vehicle surrounding information, and the display unit (display 90) that displays the composite image.

Accordingly, convenience for the riding member in a case of parking the vehicle may be improved.

### Fifth Embodiment

In a fifth embodiment, a description will be made about one example in which the opening amount of the door is calculated based on the vehicle inside-outside state information.

FIG. 16 is a schematic block diagram that illustrates one example of a function configuration of the parking position display processing apparatus 10 according to the fifth embodiment of the present disclosure.

The parking position display processing apparatus 10 is configured to include the image acquisition unit 16, the vehicle inside-outside state recognition unit 17, the vehicle information acquisition unit 18, the parking position calculation unit 19, the display image generation unit 20, the object information storage unit 21-1, the attribute information storage unit 21-2, and a door opening calculation unit 540.

Here, compared to the parking position display processing apparatus 10 according to the first embodiment, the parking position display processing apparatus 10 according to the fifth embodiment is different in a point that the door opening calculation unit 540 is added. In the fifth embodiment, a description will be made while different portions from the parking position display processing apparatus 10 according to the first embodiment are focused.

The door opening calculation unit 540 acquires the image signals that represent images that are photographed by the respective cameras (the rear camera 12, the side cameras 13, the front camera 14, and the room camera 15). Further, the door opening calculation unit 540 acquires the vehicle inside-outside state information from the vehicle inside-outside state recognition unit 17. The vehicle inside-outside state information includes the detection information and the height information that indicates the height of an object.

The door opening calculation unit 540 calculates the positional relationship between the vehicle 11 and an object such as an obstacle or approaching object (approacher) that is present around the vehicle 11. Specifically, with respect to the doors of the vehicle 11 as references, the door opening calculation unit 540 calculates the distances between the doors and objects, the moving speed of the vehicle 11 and/or the moving speeds of the objects, the moving direction of the vehicle 11 and/or the moving directions of the objects, reaching times in which the objects reach (become adjacent to) the vehicle 11, and so forth, as the positional relationships with the objects.

Further, the door opening calculation unit 540 calculates the opening amounts of the door in a prescribed number of phases, for example, three phases based on the calculated positional relationships with the objects. The door opening calculation unit 540 outputs information that indicates the calculated opening amounts of the door in the prescribed number of phases to the display image generation unit 20.

The display image generation unit 20 generates the silhouette images or door images that correspond to the opening amounts of the door in the prescribed number of phases based on the information that is input from the door opening calculation unit 540 and indicates the opening amounts of the door in the prescribed number of phases. The display image generation unit 20 superimposes (performs composition of) the generated silhouette images on the display image and causes the display 90-d to display the superimposition image.

Here, in a case where the vehicle 11 is caused to stop (stops) by putting a shift lever of the vehicle 11 in a park position, by pulling a parking brake lever, or the like and preparation for getting off the vehicle 11 is made, the display image generation unit 20 superimposes the silhouette images or door images on the display image and causes the display 90-d to display the superimposition image.

Note that in the description to the above, a description is made about one example in which the display image that is displayed on the display 90-d is based on the photographed image by the side camera 13. However, embodiments are not limited to this, but a computer graphics (CG) image that represents a detected object (obstacle) or a surrounding state on the outside of the vehicle may be generated, and the generated CG image may be displayed on the display 90-d.

Further, the display image generation unit 20 may superimpose the position information, such as the position of the object, the moving speed of the object, the moving direction of the object, or the reaching time in which the object reaches (becomes adjacent to) the vehicle 11, on the photographed image by the side camera 13 or the CG image by using a figure, an icon, animation, a character, or the like by CG and may cause the display 90-d to display the position information.

Accordingly, in a case where the vehicle 11 stops, the getting-off person may quickly know the present state on the outside of the vehicle 11 or the predicted state on the outside of the vehicle 11. Further, the getting-off person may in advance check the way of opening the door or the like, and safety may thus be secured.

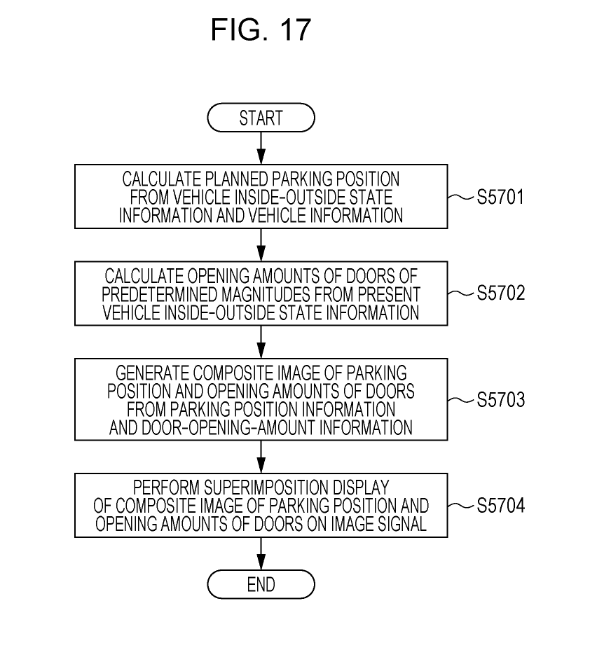

FIG. 17 is a flowchart that illustrates one example of a parking position display process according to the fifth embodiment of the present disclosure.

The parking position display processing apparatus 10 executes processes of step S5701 to step S5704 after the processes to step S14 in FIG. 5 are executed.

In step S5701, the parking position calculation unit 19 calculates the planned parking position from the vehicle inside-outside state information output from the vehicle inside-outside state recognition unit 17 and the vehicle information output by the vehicle information acquisition unit 18. The parking position calculation unit 19 outputs the calculated planned parking position as the parking position information to the door opening calculation unit 540. Then, the parking position display processing apparatus 10 executes a process of step S5702.

In step S5702, the door opening calculation unit 540 calculates the respective opening amounts of the doors in a prescribed number of phases from the vehicle inside-outside state information output from the vehicle inside-outside state recognition unit 17 and the parking position information output by the parking position calculation unit 19 and based on the prescribed number of phases and the respective opening amounts in the prescribed phases. The door opening calculation unit 540 outputs information that indicates the calculated opening amounts of the respective doors to the display image generation unit 20. Then, the parking position display processing apparatus 10 executes a process of step S5703.

In step S5703, the display image generation unit 20 generates a superimposition image, in which an image which represents an object such as an obstacle or approacher which is present in the available parking range, an image which represents the getting-off spaces, and the door images that correspond to the information which indicates the opening amounts of the doors are superimposed (composition is performed) on the parking position information, from the parking position information output by the parking position calculation unit 19 and the information that is output by the door opening calculation unit 540 and indicates the respective opening amounts of the doors. Then, the parking position display processing apparatus 10 executes a process of step S5704.

In step S5704, the display image generation unit 20 generates a composite image in which composition is performed from the image signal output from the image acquisition unit 16 and the superimposition image calculated in step S5703. Further, in a case where the display image generation unit 20 detects a fact that the vehicle 11 stops and is in a getting-off state from the vehicle inside-outside state information output from the vehicle inside-outside state recognition unit 17, the display image generation unit 20 causes the display 90-d to display the generated composite image. Then, in a case where a prescribed time elapses or a case where completion of getting-off from the vehicle 11 is detected, a process related to FIG. 17 is finished.

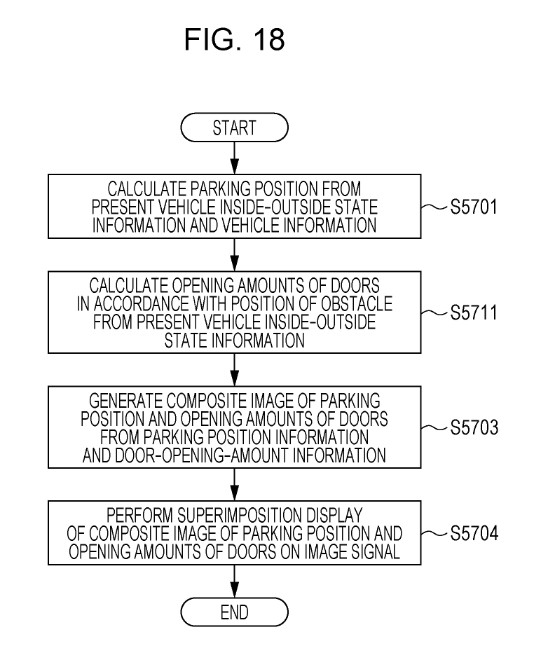

Note that the door opening calculation unit 540 may calculate the maximum opening amount of the door from an obstacle included in the vehicle inside-outside state information and the positional relationship with an object and may calculate (decide) the number of phases of the opening amount of the door or the opening amount of the door for one phase in accordance with the calculated maximum opening amount of the door. Details will be described with reference to FIG. 18.

FIG. 18 is a flowchart that illustrates one example of a parking position display process according to a modification example of the fifth embodiment of the present disclosure.

Here, in the parking position display process in FIG. 18, a process of step S5711 is executed instead of step S5702 in the parking position display process illustrated in FIG. 17. Descriptions about step S5701, step S5703, and step S5704 will not be made.

The parking position display processing apparatus 10 executes the process of step S5701 and thereafter executes the process of step S5711.

In step S5711, the door opening calculation unit 540 calculates the maximum opening amount of the door, in which the door is capable of being opened in the range in which the object does not collide with the door (for example, the range in which the distance between the vehicle and the object becomes a prescribed value (for example, 10 cm) or more), for each of the doors from the vehicle inside-outside state information output from the vehicle inside-outside state recognition unit 17 and the parking position information output by the parking position calculation unit 19 and based on the positional relationship between the vehicle 11 and an object. The door opening calculation unit 540 calculates the number of phases (for example, the number of phases that are represented by the silhouette images or door images) of the opening amount of the door in accordance with the calculated maximum opening amount of the door of each of the doors and sets and calculates the opening amount (angle) for one phase such that as for the respective opening amounts of the door in the calculated number of phases, the total of the opening amounts of the door in the respective phases is within the maximum opening amount of the door. The door opening calculation unit 540 outputs information that indicates the calculated opening amounts of the door in the respective phases and of each of the doors to the display image generation unit 20. Then, the parking position display processing apparatus 10 executes step S5703. The parking position display processing apparatus 10 executes the process of step S5704 after the process of step S5703.

As described above, the parking position display processing apparatus 10 according to the fifth embodiment includes the image capturing unit (rear camera 12) that captures an image of a surrounding of the vehicle 11 and generates a captured image, the vehicle information acquisition unit 18 that acquires the vehicle information of the vehicle 11, the vehicle surrounding state recognition unit (vehicle inside-outside state recognition unit 17) that generates the vehicle surrounding information which indicates the state of the surrounding of the vehicle 11 based on the captured image and the vehicle information, the parking position calculation unit 19 that calculates the planned parking position of the vehicle 11 based on the vehicle surrounding information and the vehicle information, the composite image generation unit (display image generation unit 20) that generates the composite image from an image which represents the planned parking position and an image which represents the state of the surrounding of the vehicle 11 in the planned parking position based on the planned parking position and the vehicle surrounding information, and the display unit (display 90) that displays the composite image.

Accordingly, convenience for the riding members in cases of parking the vehicle and of getting off the vehicle may be improved.

### Sixth Embodiment

In the first embodiment to the fifth embodiment, descriptions are made about examples in which the getting-off person is notified of where an object is present or how much the door of the vehicle 11 may be opened without contact with an object in accordance with the positional relationship between the vehicle 11 and an object such as an obstacle or an approacher.

In a sixth embodiment, a description will be made about one example in which the opening amount of the door of the vehicle 11 is controlled by an actuator.

Specifically, in the sixth embodiment, a description will be made about one example in which after the getting-off person starts opening the door of the vehicle 11, a load is applied in the door opening direction as the door approaches an object and a fact that the door is approaching the object is fed back to the getting-off person by a way of applying the load in the door opening direction.

Here, in the sixth embodiment, an actuator is provided to an open-close axis portion of the door of the vehicle 11, a force is produced in a door closing direction, and the getting-off person is thereby caused to feel a weight in the door opening direction in a case where the getting-off person attempts to open the door.

In such a manner, the getting-off person may be informed of how much the door is capable of being opened by feedback of the weight in the door opening direction.

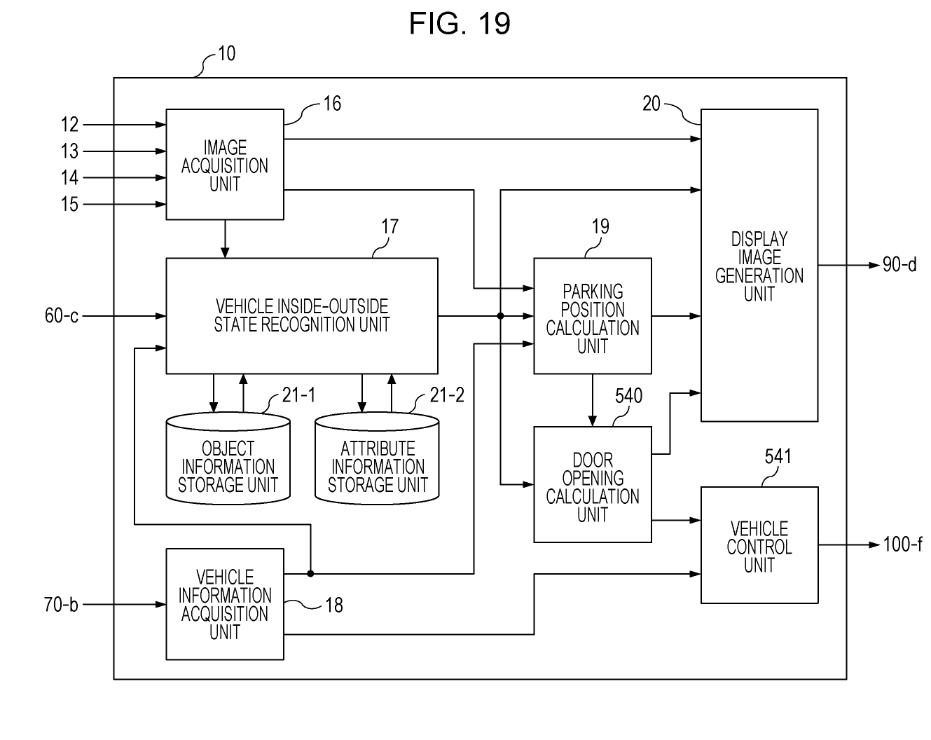

FIG. 19 is a schematic block diagram that illustrates one example of a function configuration of the parking position display processing apparatus 10 according to the sixth embodiment of the present disclosure.

The parking position display processing apparatus 10 is configured to include the image acquisition unit 16, the vehicle inside-outside state recognition unit 17, the vehicle information acquisition unit 18, the parking position calculation unit 19, the display image generation unit 20, the object information storage unit 21-1, the attribute information storage unit 21-2, the door opening calculation unit 540, and a vehicle control unit 541.

Here, compared to the parking position display processing apparatus 10 according to the fifth embodiment, the parking position display processing apparatus 10 according to the sixth embodiment is different in a point that the vehicle control unit 541 is added. In the sixth embodiment, a description will be made while different portions from the parking position display processing apparatus 10 according to the fifth embodiment are focused.

Further, the door opening calculation unit 540 calculates the actual opening amounts of the respective doors (which will be referred to as door state in the following description) of the present vehicle 11 from the image signals of images that are photographed by the respective cameras (the rear camera 12, the side cameras 13, the front camera 14, and the room camera 15). The door opening calculation unit 540 outputs information that indicates the opening amounts of the door in the prescribed number of phases and information that indicates the door state to the vehicle control unit 541.

Note that as the door state, the present opening amount of the door may be acquired by various sensors 60-c placed in the vehicle 11, or the present opening amount of the door may be calculated based on information acquired by various sensors 60-c.

The vehicle control unit 541 controls the feedback force of each of the doors by using the vehicle information output from the vehicle information acquisition unit 18, the information that is output from the door opening calculation unit 540 and indicates the opening amounts of the door in the prescribed number of phases, and the information that indicates the door state.

The vehicle control unit 541 controls the actuator that is placed in an axial portion of the door based on the information that indicates the opening amount of the door which is calculated by the door opening calculation unit 540 and the information that indicates the door state and by following the feedback force control, which will be described later, and thereby produces the feedback force in the door closing direction. The feedback force control is performed in real time in response to the door state, and the actuator is controlled through the period in which the getting-off person starts and finishes getting off the vehicle.

The vehicle control unit 541 individually controls the feedback forces for doors 100-f (f is an arbitrary integer) such as a driver seat door, a passenger seat door, a rear seat right door, a rear seat left door, and a tail door. Further, the vehicle control unit 541 controls the feedback force in real time for the door for which the getting-off person is present.

Here, a description will be made about the feedback force control.

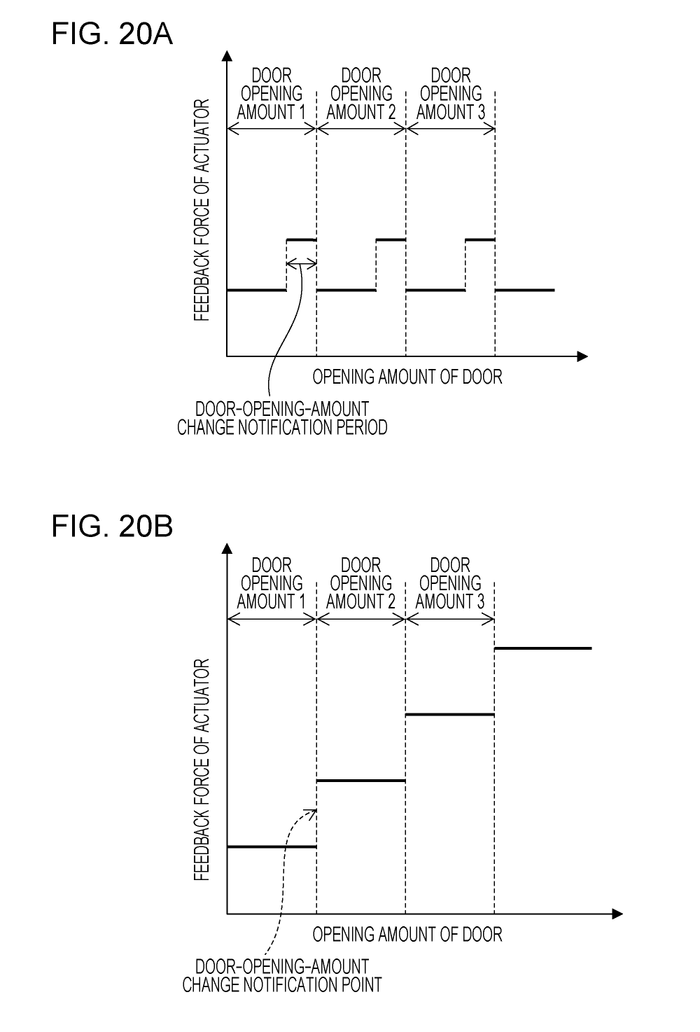

FIGS. 20A and 20B are explanatory diagrams that illustrate examples of the feedback force control according to the sixth embodiment of the present disclosure.

The examples illustrated in FIGS. 20A and 20B are examples in which the load (in the following description, feedback force) is applied in the door opening direction when the door state approaches the boundaries of the opening amounts of the door in the respective phases.

The example illustrated in FIG. 20A is a case where the feedback forces of the door are the same for the opening amounts of the door in the respective phase. A period from the start point of each door opening region to a close point to the boundary of the opening amount of the door in the next phase (for example, the remaining opening amount (angle) to the opening amount of the door in the next phase is from 10 degrees to 0 degrees) is a door-opening-amount change notification period.

The vehicle control unit 541 controls the actuator to apply the load to the door by a regular feedback force until the door-opening-amount change notification period starts and notifies the getting-off person that the door state is in the range of each opening amount of the door. Meanwhile, in a case where the door-opening-amount change notification period starts, the vehicle control unit 541 applies the load so as to make the feedback force larger and notifies the getting-off person that as for the door state, the range of the opening amount of the door in the present phase ends. For example, in a case where an object is present in the range in which the opening amount of the door becomes “door opening amount 3” which indicates the opening amount of the door in the third phase, the door may be opened until the load as the feedback force is applied two times. Thus, the getting-off person may recognize how much the door may be opened while physically feeling the change in the load (the change in the feedback force).

In the example illustrated in FIG. 20B, a description will be made about one example in which the feedback force becomes larger as the opening amount of the door becomes larger.

That is, the example illustrated in FIG. 20B is one example in which the feedback force becomes larger as the door is opened more.

In a case where a door-opening-amount change notification point is exceeded which is a boundary, at which the phases of the opening amounts of the door are changed, such as the boundary at which a change occurs from the region of “door opening amount 1” indicating the opening amount of the door in the first phase to the region of “door opening amount 2” indicating the opening amount of the door in the second phase, for example, the vehicle control unit 541 applies the load to the door so as to make the feedback force stronger (heavier) by controlling the actuator.

Accordingly, the change in the phase of the opening amount of the door may physically be recognized because of the change in the feedback force. In addition, as the door is opened more, the possibility of contact with an object increases. Thus, the load as the feedback force is applied to the door, control may thereby be performed so as to make it difficult to open the door, and it becomes possible to inhibit an accident before it happens.

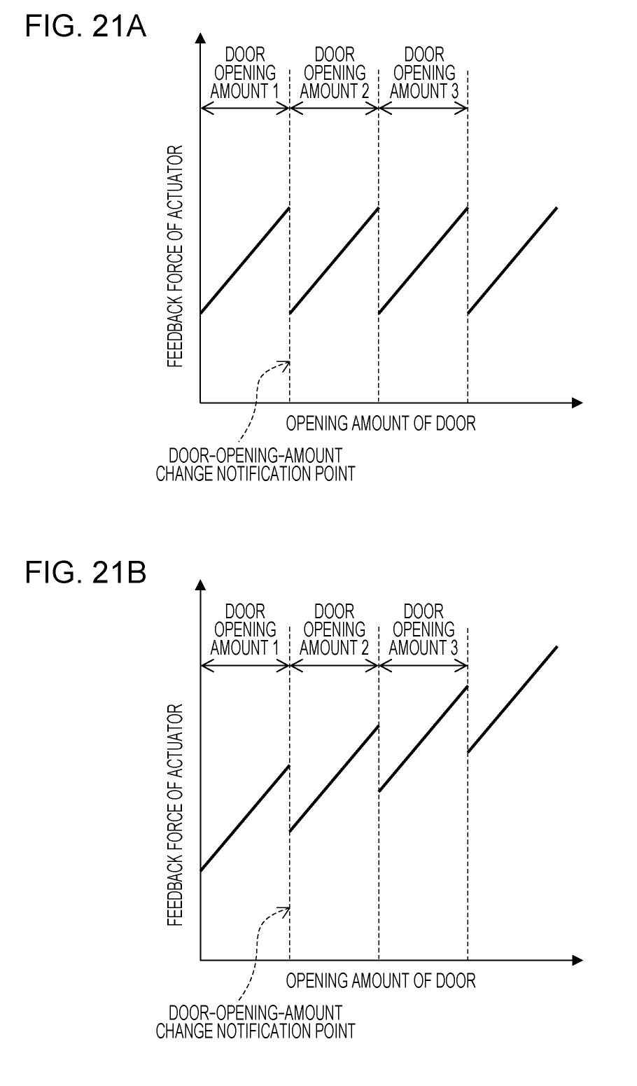

FIGS. 21A and 21B are explanatory diagrams that illustrate examples of the feedback force control according to the sixth embodiment of the present disclosure.

The example illustrated in FIG. 21A is one example in which, in the regions of the opening amounts of the door of the respective phases, with respect to each region of the opening amount of the door in the phase, the load is applied to the door by controlling the actuator such that the feedback force gradually becomes larger from the start to the end of each of the regions.

For example, the vehicle control unit 541 controls the actuator such that the load to the door gradually becomes larger while the opening amount of the door moves from the start of the region of the opening amount of the door in the first phase into the region of the opening amount of the door in the second phase, controls the actuator such that the load to the door gradually becomes larger similarly to the load in the region of the opening amount of the door in the first phase while the opening amount of the door moves from the start of the region of the opening amount of the door in the second phase into the region of the opening amount of the door in the third phase, and controls the actuator such that the load to the door gradually becomes larger from the start of the region of the opening amount of the door in the third phase to the end of the opening amount of the door in the third phase.

In such a manner, the gradual change in the region of the opening amount of the door may be recognized while the change is physically felt.

The example illustrated in FIG. 21B is a case where, in the regions of the opening amounts of the door in the respective phases, the feedback force also becomes larger in response to the phase shift to the higher phase.

For example, similarly to FIG. 21A, the vehicle control unit 541 controls the actuator such that the load to the door gradually becomes larger while the opening amount of the door moves from the start of the region of the opening amount of the door in the first phase into the region of the opening amount of the door in the second phase, also controls the actuator such that the load to the door gradually becomes larger while the opening amount of the door moves from the start of the region of the opening amount of the door in the second phase into the region of the opening amount of the door in the third phase, and also controls the actuator such that the load to the door gradually becomes larger from the start of the region of the opening amount of the door in the third phase to the end of the region of the opening amount of the door in the third phase.

Here, the vehicle control unit 541 controls the actuator such that the load to the door at the start of the region of the opening amount of the door in the second phase becomes larger than the load to the door at the start of the region of the opening amount of the door in the first phase and becomes smaller than the load to the door at the end of the region of the opening amount of the door in the first phase. Further, the vehicle control unit 541 controls the actuator such that the load to the door at the start of the region of the opening amount of the door in the third phase becomes larger than the load to the door at the start of the region of the opening amount of the door in the second phase and becomes smaller than the load to the door at the end of the region of the opening amount of the door in the second phase.

That is, the vehicle control unit 541 controls the actuator such that the load at the start of each of the regions becomes larger at each time when the phase of the region of the opening amount of the door is shifted to the higher phase and the load gradually becomes larger in each of the regions.

In such a manner, by the load to the door, the region of the opening amount of the door in which phase the present door state is in may be recognized.

Note that in the examples illustrated in FIGS. 21A and 21B, because the load to the door becomes lighter at the timing when the region of the opening amount of the door changes, the door is easily opened in a case where the door is forcefully opened, for example. Thus, the door is desirably opened carefully, but embodiments are not limited to this.

Further, the examples illustrated in FIGS. 21A and 21B are desirably used in a place where the traffic is heavy, a case where the wind blows hard, or the like, for example. However, embodiments are not limited to this.

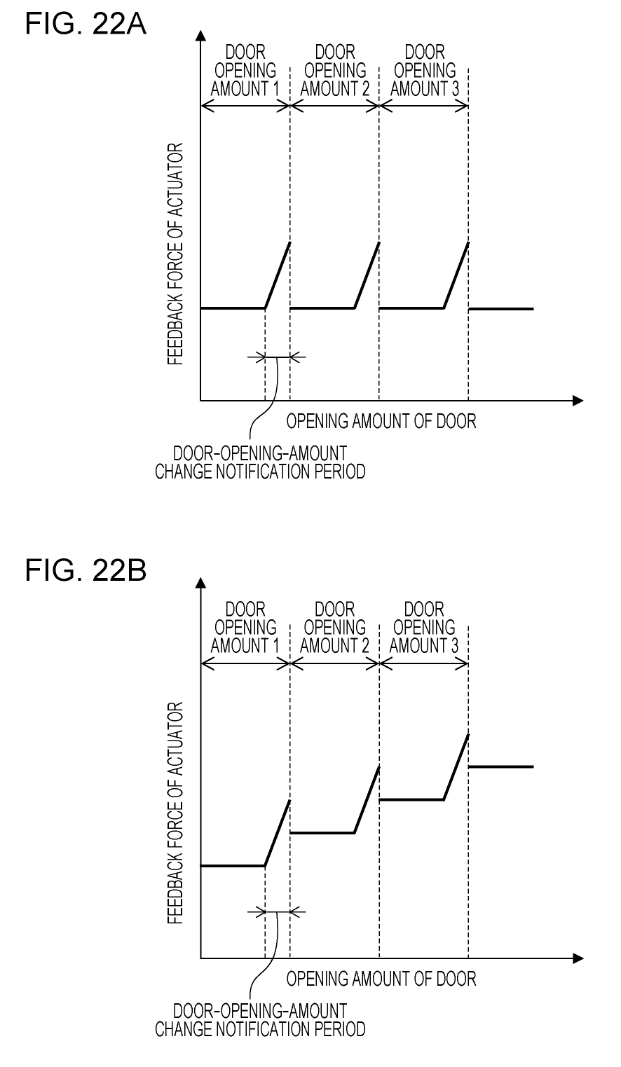

FIGS. 22A and 22B are explanatory diagrams that illustrate examples of the feedback force control according to the sixth embodiment of the present disclosure.

The example illustrated in FIG. 22A is a case where the feedback forces of the door are the same for the opening amount of the door in each phase. A period from the start point of the region of each opening amount of the door to a close point to the boundary of the opening amount of the door in the next phase (for example, the remaining opening amount (angle) to the opening amount of the door in the next phase is from 10 degrees to 0 degrees) is the door-opening-amount change notification period.

The vehicle control unit 541 controls the actuator to apply the load to the door by a regular feedback force until the door-opening-amount change notification period starts and notifies the getting-off person that the door state is in the range of each opening amount of the door. Meanwhile, in a case where the door state becomes the door-opening-amount change notification period, the vehicle control unit 541 applies the load so as to gradually make the feedback force larger and notifies the getting-off person that as for the door state, the range of the opening amount of the door in the present phase ends. For example, in a case where an object is present in the region of the opening amount of the door of “door opening amount 3” that indicates the opening amount of the door in the third phase, the door may be opened until the load as the feedback force is applied two times. Thus, the getting-off person may recognize how much the door may be opened while physically feeling the change in the load (the change in the feedback force).

Further, although not in the door-opening-amount change notification period, because a prescribed load is applied to the door, it becomes difficult to perform rapid opening, closing, or the like of the door, and the possibility of contact with an object may be lowered.

The example illustrated in FIG. 22B is one example in which, in the regions of the opening amounts of the door in the respective phases, the feedback force also becomes larger in response to the phase shift to the higher phase.

In the example illustrated in FIG. 22B, a period from the start point of the region of each opening amount of the door to a close point to the boundary of the opening amount of the door in the next phase (for example, the remaining opening amount (angle) to the opening amount of the door in the next phase is from 10 degrees to 0 degrees) is the door-opening-amount change notification period.

In the region of the opening amount of the door in each phase, the vehicle control unit 541 controls the actuator to apply the load to the door by a regular feedback force until the door-opening-amount change notification period starts and notifies the getting-off person that the door state is in the range of each opening amount of the door. Meanwhile, in a case where the door state becomes the door-opening-amount change notification period, the vehicle control unit 541 applies the load so as to gradually make the feedback force larger than the feedback force at a time before the door-opening-amount change notification period and notifies the getting-off person that as for the door state, the range of the opening amount of the door in the present phase ends. For example, in a case where an object is present in the region of the opening amount of the door of “door opening amount 3” that indicates the opening amount of the door in the third phase, the door may be opened until the load as the feedback force is applied two times.

Here, the vehicle control unit 541 controls the actuator such that the load to the door at the start of the region of the opening amount of the door in the second phase becomes larger than the load to the door at the start of the region of the opening amount of the door in the first phase and becomes smaller than the load to the door at the end of the region of the opening amount of the door in the first phase. Further, the vehicle control unit 541 controls the actuator such that the load to the door at the start of the region of the opening amount of the door in the third phase becomes larger than the load to the door at the start of the region of the opening amount of the door in the second phase and becomes smaller than the load to the door at the end of the region of the opening amount of the door in the second phase.

That is, the vehicle control unit 541 controls the actuator such that the load at the start of each of the regions becomes larger at each time when the phase of the region of the opening amount of the door is shifted to the higher phase and the load gradually becomes larger in each of the regions.

In such a manner, by the load to the door, the region of the opening amount of the door in which phase the present door state is in may be recognized. Thus, how much the door may be opened may be recognized while the change in the load (the change in the feedback force) is physically felt. Further, although not in the door-opening-amount change notification period, because a prescribed load is applied to the door, it becomes difficult to perform rapid opening, closing, or the like of the door, and the possibility of contact with an object may be lowered.

As described above, the vehicle control unit 541 controls the actuator and applies the load to the door by using any of the pieces of feedback force control, which are described in FIG. 20A to FIG. 22B.

Accordingly, in a case where the door is opened, the getting-off person may physically recognize the sense of distance between an object and the door or the position in which an object is present by the feedback to the door without carefully opening the door while watching the safety information display and may easily perform opening and closing of the door. In addition, the load by the actuator in the door opening direction is made larger (stronger and larger) before contact with an object, and the possibility that the door contacts with an object may thereby be lowered.

Further, the door may be controlled to a state where the door does not open any more before contact with an object. However, the door is controlled not to a state where the door does not open but to a state where the door is difficult to open, and a situation in which the door is controlled so as not to open due to detection of an obstacle may thereby be inhibited in a case where the obstacle appears around the door due to a traffic accident or the like.

Note that the load (feedback force) in the door opening direction may be set in accordance with the attribute (for example, age, height, sex, or the like) of the getting-off person. In this case, for example, in accordance with the age or sex of the riding member, which is detected from the photographed image by the room camera 15, the feedback force may be made light (weak) for a child or an elderly person compared to an adult, or the feedback force may be made light (weak) for a women compared to a man. A load sensor that is capable of detecting the body weight may be provided to each seat, and the feedback force may thereby be changed in accordance with the body weight of the riding person. The height of the head of the riding person may be detected from the photographed image by the room camera 15 to calculate the height, and the feedback force may thereby be changed in accordance with the height (sitting height) of the riding person.

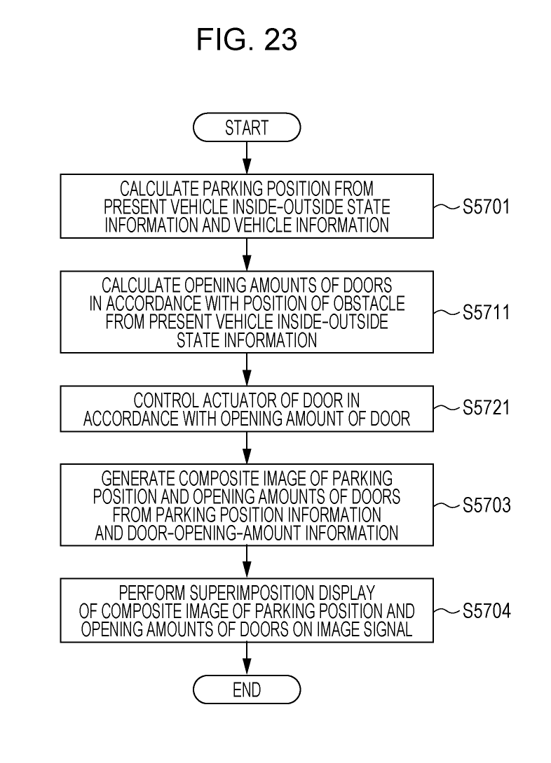

FIG. 23 is a flowchart that illustrates one example of a parking position display process according to the sixth embodiment of the present disclosure.

Here, the processes related to step S5701, step S5703, and step S5704 are similar to step S5701, step S5703, and step S5704 illustrated in FIG. 17, and a description will thus not be made. Further, the process related to step S5711 is similar to step S5711 in FIG. 18, and a description will thus not be made.

The parking position display processing apparatus 10 executes the process of step S5701 and thereafter executes the process of step S5711. The parking position display processing apparatus 10 thereafter executes a process of step S5721.

In step S5721, the vehicle control unit 541 controls the actuator based on the information indicating the opening amount of the door and the information indicating the door state, which are output from the door opening calculation unit 540, and the vehicle information 1-b output from the vehicle information acquisition unit 18 and in accordance with the opening amounts of the door in the phases and the present position of the door and thereby produces the feedback force in the door closing direction. The feedback force control is executed in real time for each of the doors and in response to the door state. Subsequently, the parking position display processing apparatus 10 executes the processes of step S5703 and step S5704.

As described above, the parking position display processing apparatus 10 according to the sixth embodiment includes the image capturing unit (rear camera 12) that captures an image of a surrounding of the vehicle 11 and generates a captured image, the vehicle information acquisition unit 18 that acquires the vehicle information of the vehicle 11, the vehicle surrounding state recognition unit (vehicle inside-outside state recognition unit 17) that generates the vehicle surrounding information which indicates the state of the surrounding of the vehicle 11 based on the captured image and the vehicle information, the parking position calculation unit 19 that calculates the planned parking position of the vehicle 11 based on the vehicle surrounding information and the vehicle information, the composite image generation unit (display image generation unit 20) that generates the composite image from an image which represents the planned parking position and an image which represents the state of the surrounding of the vehicle 11 in the planned parking position based on the planned parking position and the vehicle surrounding information, and the display unit (display 90) that displays the composite image.

Accordingly, convenience for the riding member in a case of parking the vehicle may be improved.

Note that a program that acts in the parking position display processing apparatus 10 in one aspect of the present disclosure may be a program (a program that causes a computer to function) that controls one or plural processors such as central processing units (CPUs) so that functions described in the above embodiments and modification example related to one aspect of the present disclosure are realized. Further, information that is dealt with by those apparatuses is temporarily accumulated in a random access memory (RAM) during processing of the information and is thereafter stored in various storages such as a flash memory and a hard disk drive (HDD). The information may be read out, corrected, and written by the CPU in accordance with a request.

Note that a portion or all of the parking position display processing apparatuses 10 in the above-described embodiments and modification example may be realized by a computer that includes one or plural processors. In such a case, a program for realizing the control functions is recorded in a computer-readable recording medium, the program that is recorded in the recording medium is read and executed by a computer system, and the control functions may thereby be realized.

Note that the “computer system” herein is a computer system that is built in the parking position display processing apparatus 10 and includes an OS and hardware such as peripheral equipment. Further, “computer-readable recording media” are portable media such as flexible disks, magneto-optical disks, ROMs, and CD-ROMs and storage apparatuses such as hard disks that are built in the computer system.

In addition, the “computer readable recording media” may include elements that dynamically retain the program for a short period of time like communication wires in a case where the program is transmitted via a network such as the Internet and a communication line such as a telephone line and elements that retain the program for a certain period of time such as volatile memories in the computer systems that are servers or clients in the above case. Further, the program may realize a portion of the above-described functions and may further be realized in combination with a program that has the above-described functions already recorded in the computer system.

Further, a portion or the whole of the parking position display processing apparatus 10 in the above-described embodiments and modification example may typically be realized as an LSI that is an integrated circuit or may be realized as a chipset. Further, function blocks of the parking position display processing apparatus 10 in the above-described embodiments and modification example may individually be formed into chips, or a portion or all of those may be integrated into a chip. Further, a method of forming the integrated circuit is not limited to an LSI, but the integrated circuit may be realized as a dedicated circuit and/or a general purpose processor. Further, in a case where a technology of forming an integrated circuit that replaces the LSI emerges as a result of progress of a semiconductor technology, an integrated circuit by the technology may be used.

In the foregoing, the embodiments and the modification example as aspects of the present disclosure have been described with reference to the drawings. However, specific configurations are not limited to the embodiments and the modification example, and the present disclosure includes design modifications and so forth within a scope that does not depart from the gist of the present disclosure. Further, various modifications of aspects of the present disclosure are possible, and embodiments that are obtained by appropriately combining a portion or all of technical measures that are disclosed in different embodiments are included in the technical scope of the present disclosure. Further, the technical scope of the present disclosure includes configurations in which elements which are described in the above embodiments and modification example and provide similar effects are mutually substituted.

For example, one aspect of the present disclosure may be realized by combining a portion or all of the above embodiments and modification example.

The present disclosure contains subject matter related to that disclosed in Japanese Priority Patent Application JP 2017-193099 filed in the Japan Patent Office on Oct. 2, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A parking position display processing apparatus comprising:
an image capturing unit that captures an image of a surrounding of a vehicle and generates a captured image;
a vehicle information acquisition unit that acquires vehicle information of the vehicle;
a vehicle surrounding state recognition unit that generates vehicle surrounding information which indicates a state of a surrounding of the vehicle based on the captured image and the vehicle information;
a parking position calculation unit that calculates a planned parking position of the vehicle based on the vehicle surrounding information and the vehicle information;
a composite image generation unit that generates a composite image from an image which represents the planned parking position and an image which represents the state of the surrounding of the vehicle in the planned parking position based on the planned parking position and the vehicle surrounding information; and
a display unit that displays the composite image.

2. The parking position display processing apparatus according to claim 1, wherein
the composite image generation unit causes the display unit to display the composite image in which composition is performed from the image which represents the planned parking position and an image which represents the state of the surrounding of the vehicle in the planned parking position.

3. The parking position display processing apparatus according to claim 1, wherein
the parking position calculation unit calculates a candidate of the planned parking position in which an object which is present in a region of the planned parking position and included in the vehicle surrounding information is avoided, and
the composite image generation unit generates a composite image from an image which represents the state of the surrounding of the vehicle in the candidate of the planned parking position, the captured image, the image which represents the planned parking position, and the image which represents the state of the surrounding of the vehicle in the planned parking position and causes the display unit to display the composite image.

4. The parking position display processing apparatus according to claim 1, further comprising:
an inside image capturing unit that captures an image of an inside of the vehicle and generates a captured inside image, wherein
the vehicle surrounding state recognition unit calculates a riding position of a riding person of the vehicle and an age of the riding person of the vehicle based on the captured inside image,
the parking position calculation unit calculates a candidate of the planned parking position such that a first getting-off region around a side surface of the vehicle, which is closest to the riding position of the riding person, becomes wider than a second getting-off region on an opposite side to the first getting-off region based on the calculated age of the riding person, and
the composite image generation unit generates a composite image from the captured image, the image which represents the planned parking position, the image which represents the state of the surrounding of the vehicle in the planned parking position, and an image which represents the state of the surrounding of the vehicle in the candidate of the planned parking position and causes the display unit to display the composite image.

5. The parking position display processing apparatus according to claim 1, wherein
in a case where an age of the riding person is assessed as less than a first prescribed age or in a case where the age of the riding person is a second prescribed age or more, in the planned parking position, a getting-off region is wider than a case where the age of the riding person is the first prescribed age or more and less than the second prescribed age.

6. The parking position display processing apparatus according to claim 4, wherein
the parking position calculation unit compares the first getting-off region which is closest to the riding person with the second getting-off region on the opposite side to the first getting-off region and calculates a wider getting-off region between the first getting-off region and the second getting-off region as a getting-off position, and
the composite image generation unit generates an image which represents the getting-off position of the riding person and causes the display unit to display a composite image of the captured image, the image which represents the getting-off position, the image which represents the state of the surrounding of the vehicle in the planned parking position, and the image which represents the state of the surrounding of the vehicle in the candidate of the planned parking position.

7. The parking position display processing apparatus according to claim 6, further comprising:
a side surface image capturing unit that captures an image of a side surface of the vehicle from a front to a rear of the vehicle and generates a side surface image; and
a door opening calculation unit that calculates an opening amount of a door in which the door of the vehicle is capable of being opened, wherein
the composite image generation unit generates an image which represents the opening amount of the door based on the opening amount of the door and causes the display unit to display a composite image in which composition is performed from the side surface image, the image which represents the state of the surrounding of the vehicle in the candidate of the planned parking position, the captured image, the image which represents the state of the surrounding of the vehicle in the planned parking position, and the image which represents the getting-off position.

8. The parking position display processing apparatus according to claim 7, wherein
the door opening calculation unit calculates the opening amount of the door between the vehicle and an object from position information of the object that is indicated by the vehicle surrounding information and the planned parking position.

9. The parking position display processing apparatus according to claim 7, further comprising:
an actuation unit that produces a force in a direction to close the door of the vehicle, wherein
in a case where a position of the door reaches a close region to a boundary of a next region in a region in which the door is capable of being opened and closed and which is indicated by at least one of the opening amounts of the door,
the actuation unit exerts the force in the direction to close the door of the vehicle and notifies the riding person that a present position of the door is the close region.

10. The parking position display processing apparatus according to claim 9, wherein
the force that is exerted in the direction to close the door of the vehicle is changed in each region in which the door is capable of being opened and closed, and the force that is exerted in the direction to close the door becomes greater as the opening amount of the door increases.

11. The parking position display processing apparatus according to claim 9, wherein
in a case where the door of the vehicle approaches a position of an object based on position information of the object that is indicated by the vehicle surrounding information, the force that is exerted in the direction to close the door of the vehicle is made greater than other cases.

12. A parking position display method causing a computer of a parking position display processing apparatus that includes an image capturing unit which captures an image of a surrounding of a vehicle and generates a captured image and a display unit to execute a process comprising:
acquiring vehicle information of the vehicle;
generating vehicle surrounding information that indicates a state of a surrounding of the vehicle based on the captured image and the vehicle information;
calculating a planned parking position of the vehicle based on the vehicle surrounding information and the vehicle information;
generating a composite image from an image which represents the planned parking position and an image which represents the state of the surrounding of the vehicle in the planned parking position based on the planned parking position and the vehicle surrounding information; and
displaying the composite image by the display unit.

13. A program causing a computer of a parking position display processing apparatus that includes an image capturing unit which captures an image of a surrounding of a vehicle and generates a captured image and a display unit to execute a process comprising:
acquiring vehicle information of the vehicle;
generating vehicle surrounding information that indicates a state of a surrounding of the vehicle based on the captured image and the vehicle information;
calculating a planned parking position of the vehicle based on the vehicle surrounding information and the vehicle information;
generating a composite image from an image which represents the planned parking position and an image which represents the state of the surrounding of the vehicle in the planned parking position based on the planned parking position and the vehicle surrounding information; and
displaying the composite image by the display unit.
